(19) United States
(12) Patent Application Publication
(10) Pub. No.: US 2016/0019811 A1
(43) Pub. Date: Jan. 21, 2016

(54) ALPHABET TEACHING AND LEARNING METHOD, SYSTEM AND SOFTWARE PRODUCT

(71) Applicant: Malissa LELINSKI, Milwaukee, WI (US)

(72) Inventor: Malissa Lelinski, Milwaukee, WI (US)

(21) Appl. No.: 14/773,258

(22) PCT Filed: Mar. 6, 2013
(86) PCT No.: PCT/US2013/029280

§ 371 Date: Sep. 4, 2015

(51) Int. Cl. G09B 17/00; G09B 5/06

(52) U.S. Cl. CPC G09B 17/00; G09B 5/06; G09B 17/006

(57) ABSTRACT

A method, system and software product is used to teach the English alphabet to young children. The method uses physical positioning by the teacher followed by physical movements and audible sounds that can be mimicked by the children which will assist them in learning the English alphabet. That is, first and second visual cues are used together with an audible sound to convey the intended sound profile for each letter of the English alphabet. To the extent that electronic data processing and digital communication technologies can enable such a method, it is possible to teach the lessons remotely or by the use of a specialized software product.

### FIELD OF THE INVENTION

The present invention relates generally to the methods and systems that are used by instructors to teach the English alphabet to children. It also relates generally to computer program and software products that are used for instructional purposes.

More particularly, the present invention relates to the use of physical movements and audible sounds that are used by an instructor and mimicked by students to assist the students in learning the English alphabet through an understanding as to how each letter of the English alphabet should sound. It also relates to such a method that could be used alternatively within a computer program product, within a web-based (i.e. utilized by means of the virtual community that exists on the “internet” or within the “world wide web,” or “www”) platform, or within other electronic means for implementing the teaching method of the present invention and making the teaching method electronically available for instructors and students.

### BACKGROUND OF THE INVENTION

Since the inception of the use of the human languages, teaching lessons have been provided to pass along developed language skills to willing students. In the modern age, it has been recognized that most teaching skills, including language teaching skills, require the instructor or teacher to be engaging, informative and provide relevant positive examples to the students. These considerations are significantly more important the younger the student in view of the limited attention span of children. Moreover, it has been recognized the teachers should possess skills and capacity to make learning fun and relevant to the students. Other concepts that aid in teaching are using visual cues and repetition to reinforce the learned subject matter.

In view of the foregoing, this inventor strongly believes that what is needed is an improved method, system and software product for teaching the English alphabet to children. Such a method would use physical movements and audible sounds that can be mimicked by the students which will assist them in learning the English alphabet. To the extent that electronic data processing and digital communication technologies can enable such a method, it is possible to teach the lessons remotely or by the use of specialized software.

### SUMMARY OF THE INVENTION

In accordance with the foregoing, this inventor has devised a method for teaching the English language to students using a structured format that incorporates visual and audio cues provided by the teacher and mimicked by the students to help the students learn the English alphabet and, more importantly, how each letter in the English alphabet may sound. This method incorporates a system of movements and visual gestures to suggest or link the letters to things or concepts that are familiar to students. In doing so, this reinforces the learning capacity of the student. It is also within the scope of the present invention to provide an audiovisual component that can be recorded and presented by means of current electronic technology including a computer program product that is embodied in a non-transitory computer readable medium comprising computer instructions for practicing the method and system of the present invention.

The foregoing and other features of the method, system and software product of the present invention will become apparent from the detailed description that follows.

### BRIEF DESCRIPTION OF THE DRAWINGS

FIGS. 1 through 125 are discrete displays illustrating the teaching and learning method for all of the letters of the English alphabet, which method is disclosed in accordance with the present invention.

### DETAILED DESCRIPTION

As a prefatory statement, the method of the present invention comprises specific body positions and movements, together with sounds, that relate to each letter of the alphabet. That is, visual and audible components are used by the teacher and likewise used by the students to reinforce the learning method of the present invention. The inventor of the present invention has found that optimal teaching and learning is realized when the teacher and student repeat the movements and sounds several times, preferably three times. This repetition reinforces the learning experience and aids in student retention of the underlying concept.

Referring now specifically to the drawings, it will be seen that each letter of the alphabet has at least one sound and movement associated with it. Technically speaking, a “vowel” of the English language is defined as a speech sound that is produced by a comparatively open configuration of the vocal tract, with vibration of the vocal cords but without audible friction. In short, it is an open sound produced by the voice. On the other hand, a “consonant” of the English language is a basic speech sound in which the breath is at least partly obstructed. In short, a consonant is any letter that is not a vowel. Because vowels have more than one phonetic profile, several sounds and movements are necessarily associated with each such profile in accordance with the present invention. Multiple sound profiles are not, however, unique to vowels. Certain consonants, such as “C,” “G,” and “X” have more than one sound. Also, the letter “Y” can be either a vowel or a consonant. For purposes of this detailed description, the method and system in accordance with the present invention will first address vowels and then consonants, with the letter “Y” being considered herein as a consonant.

### Vowels

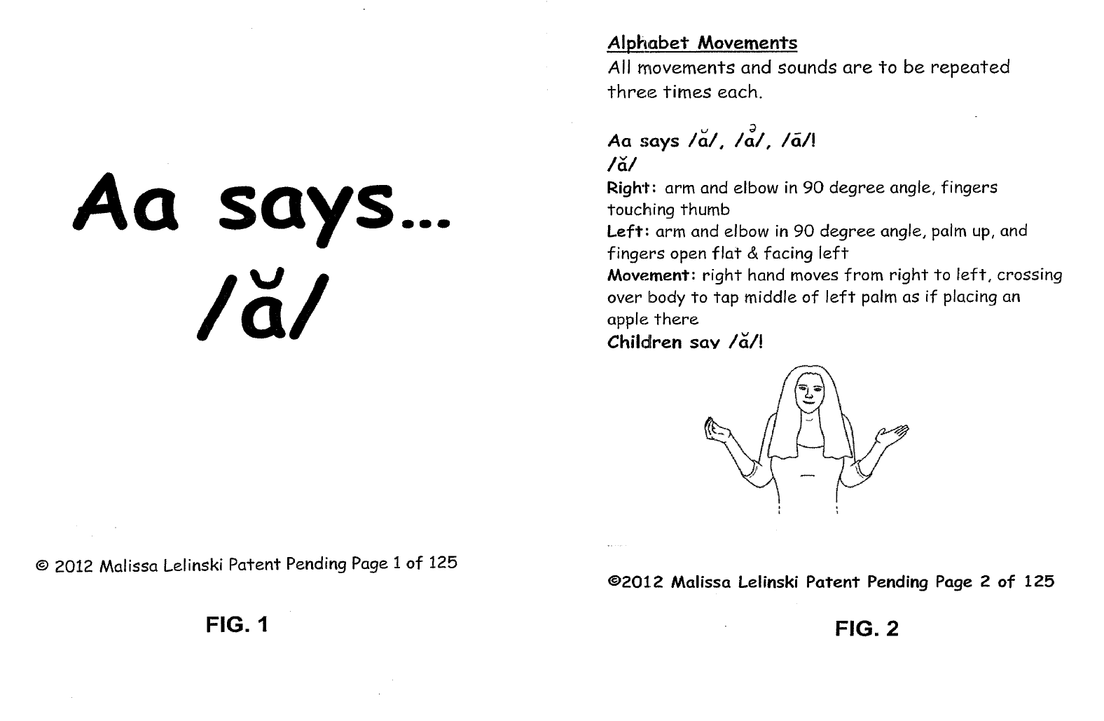

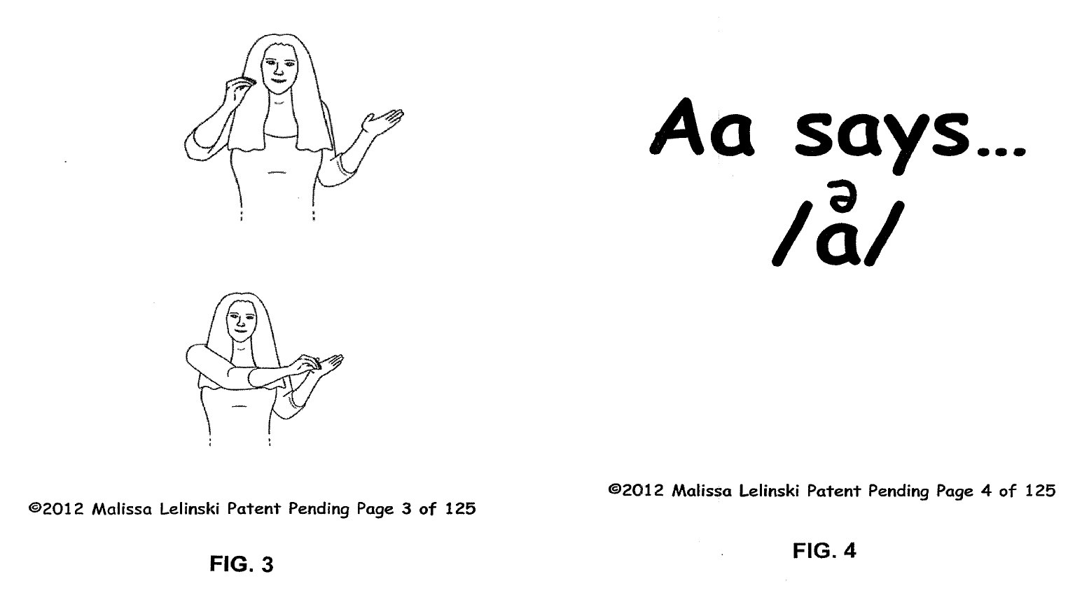

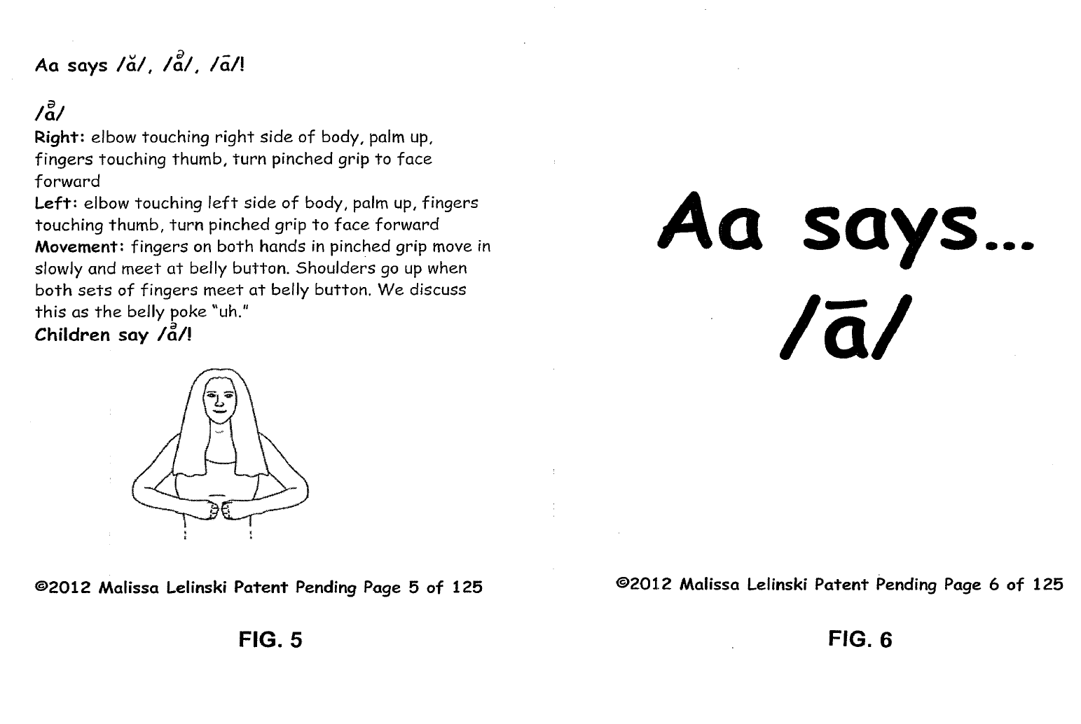

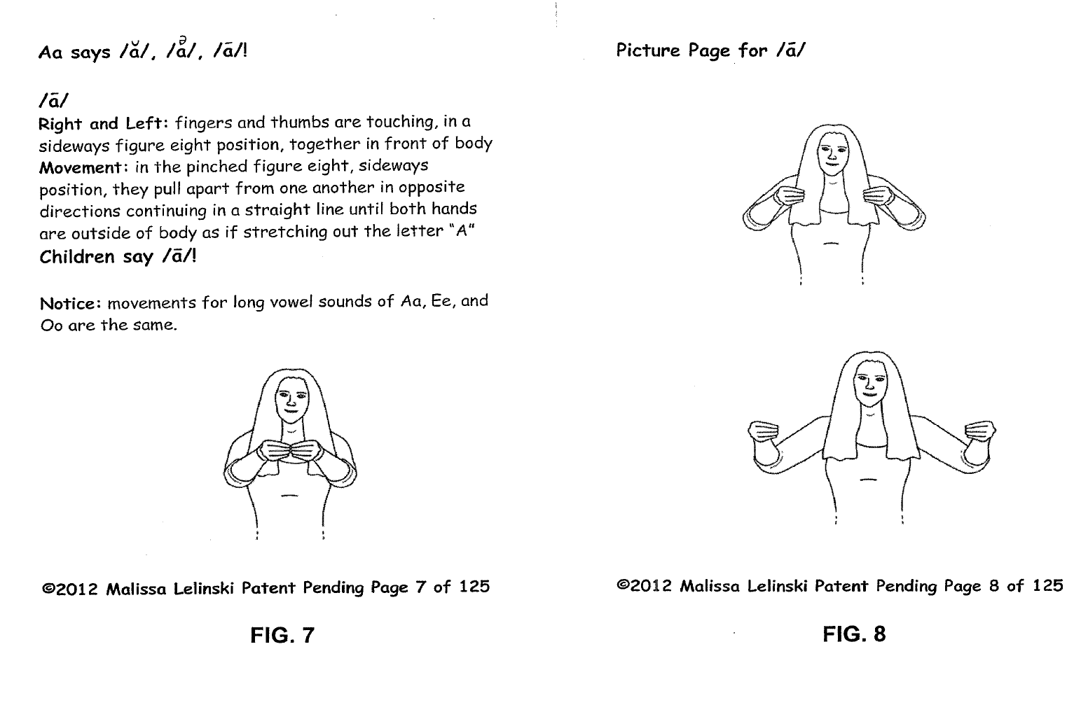

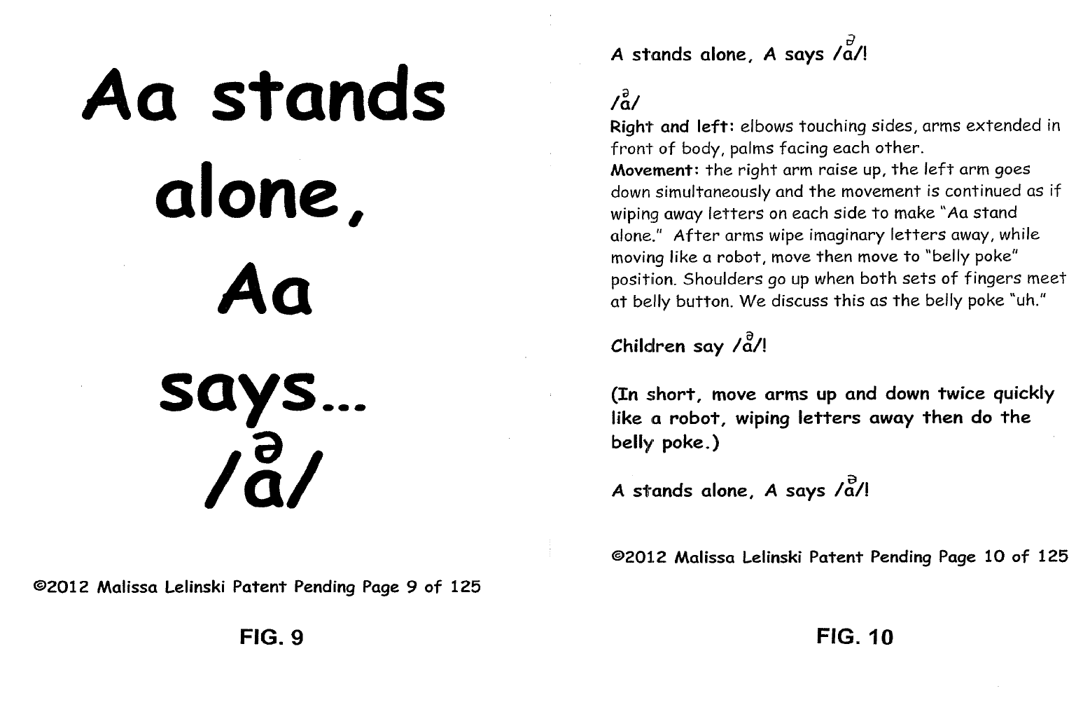

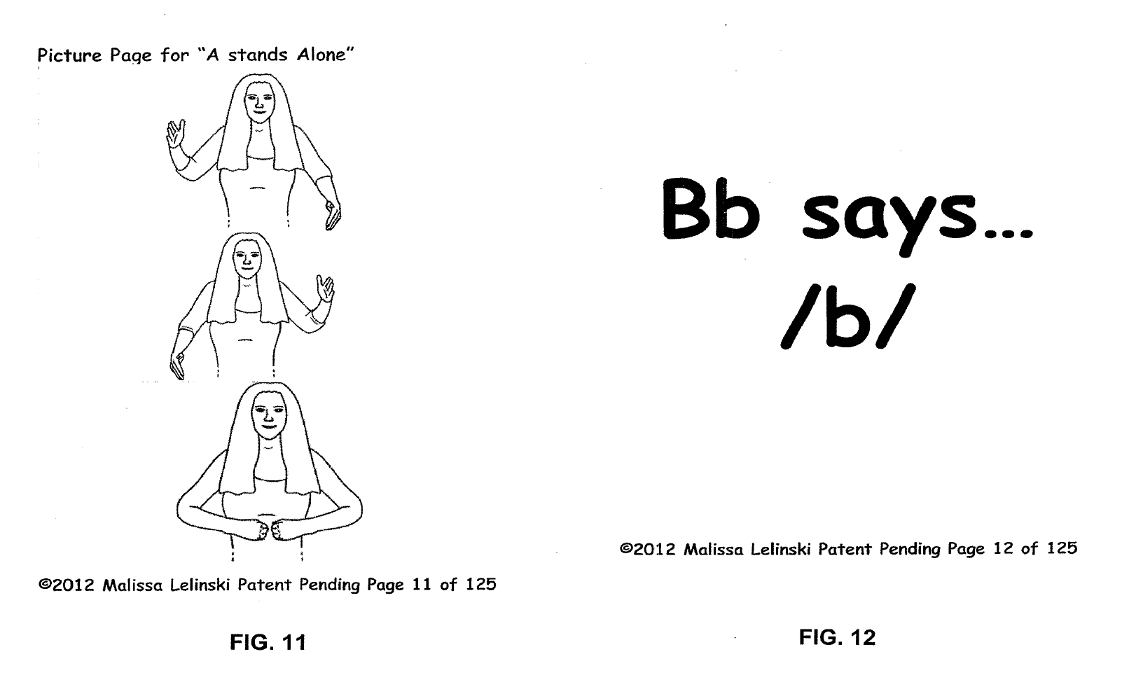

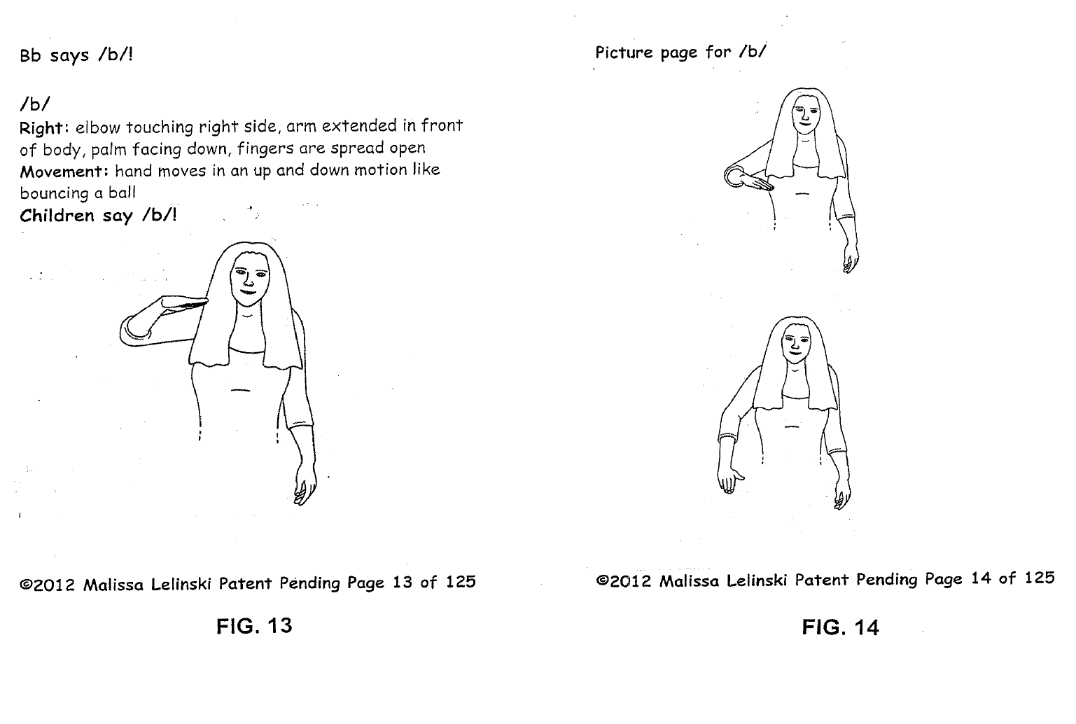

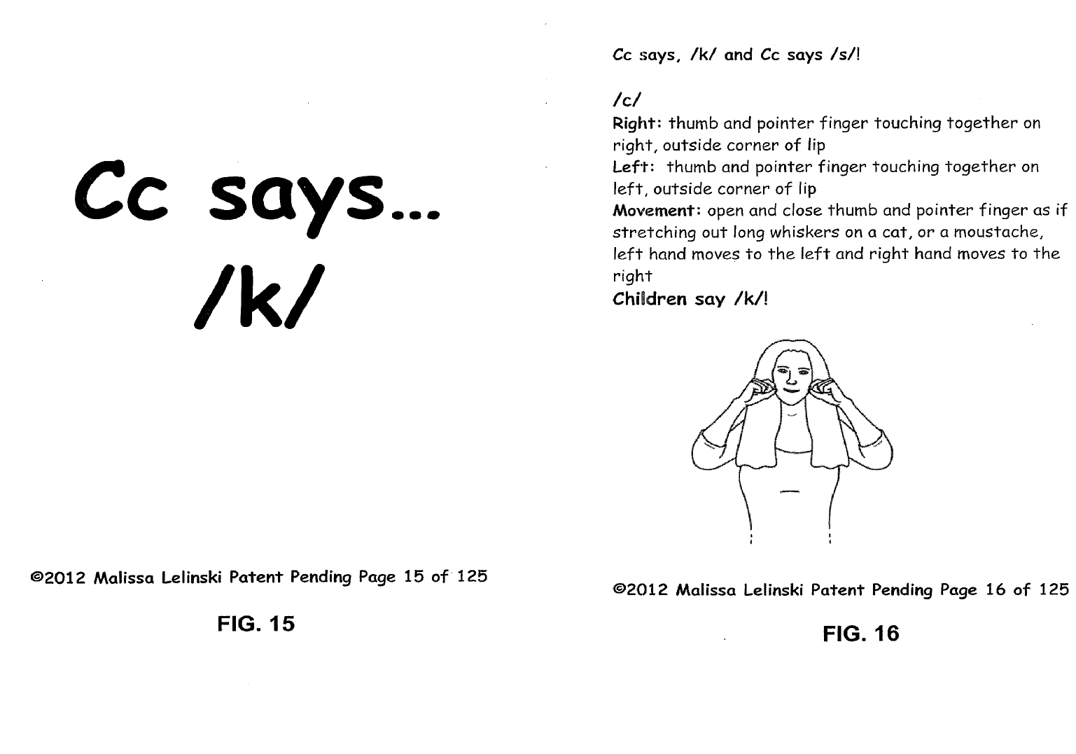

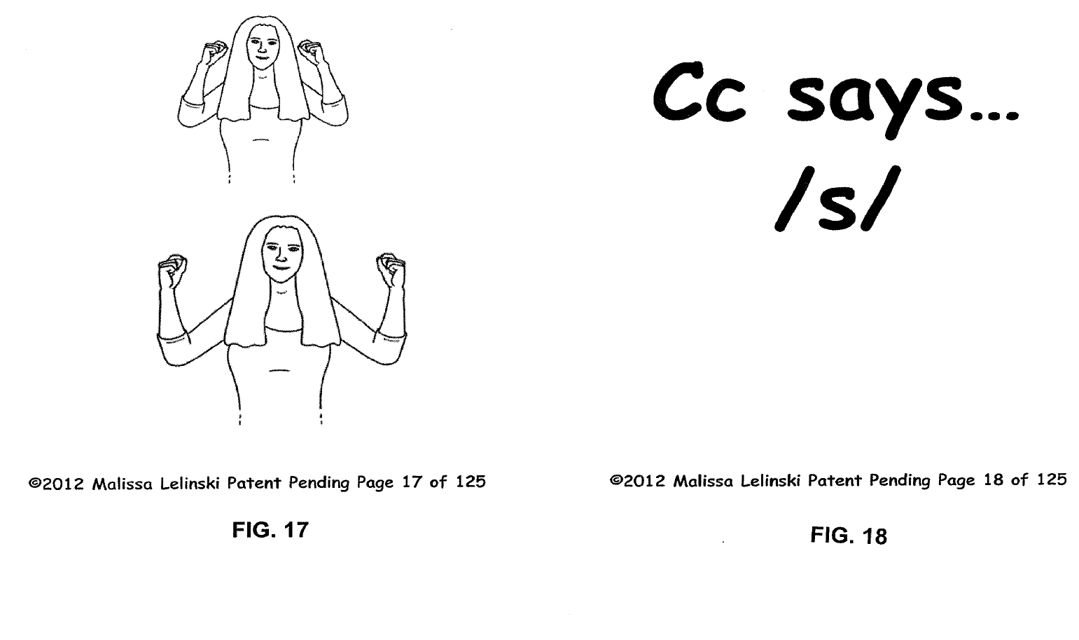

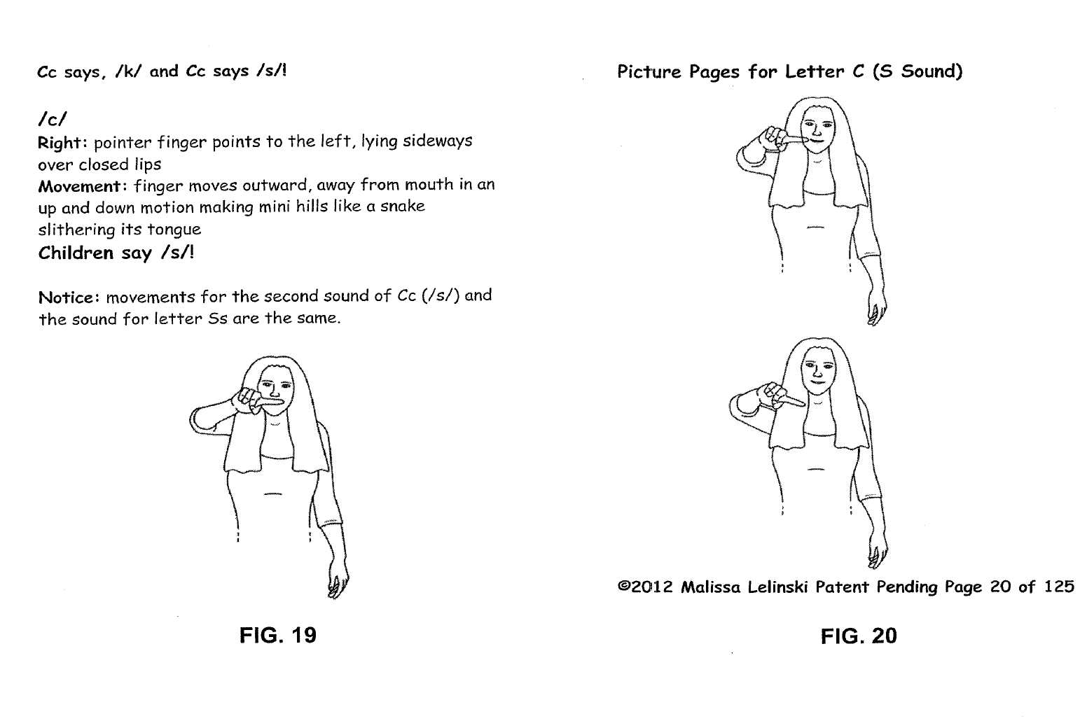

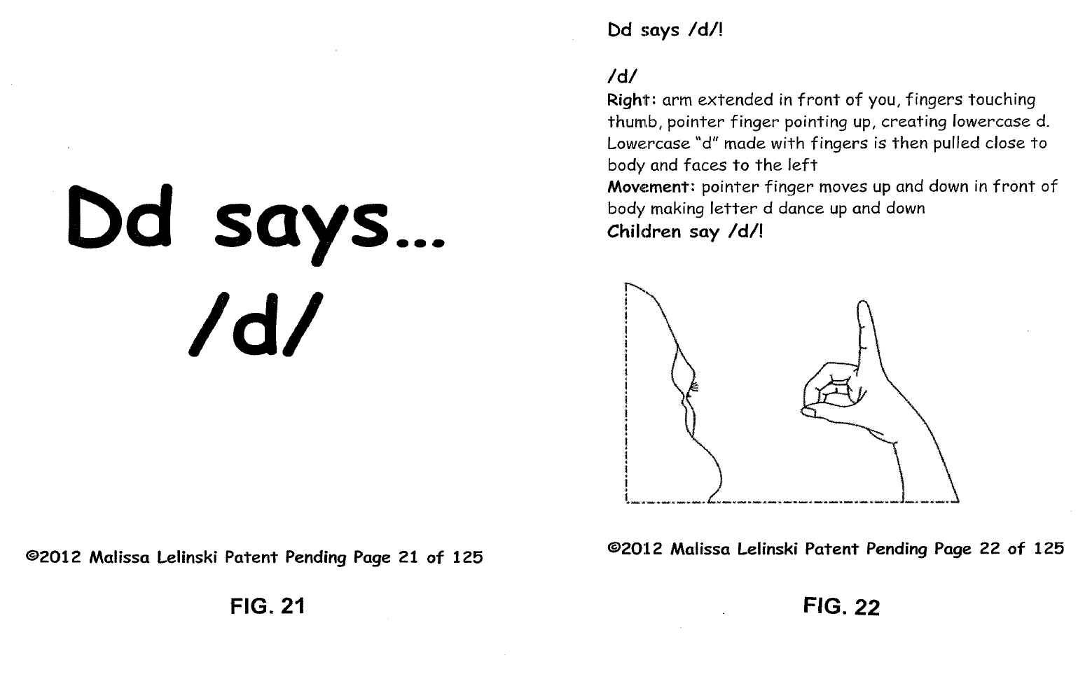

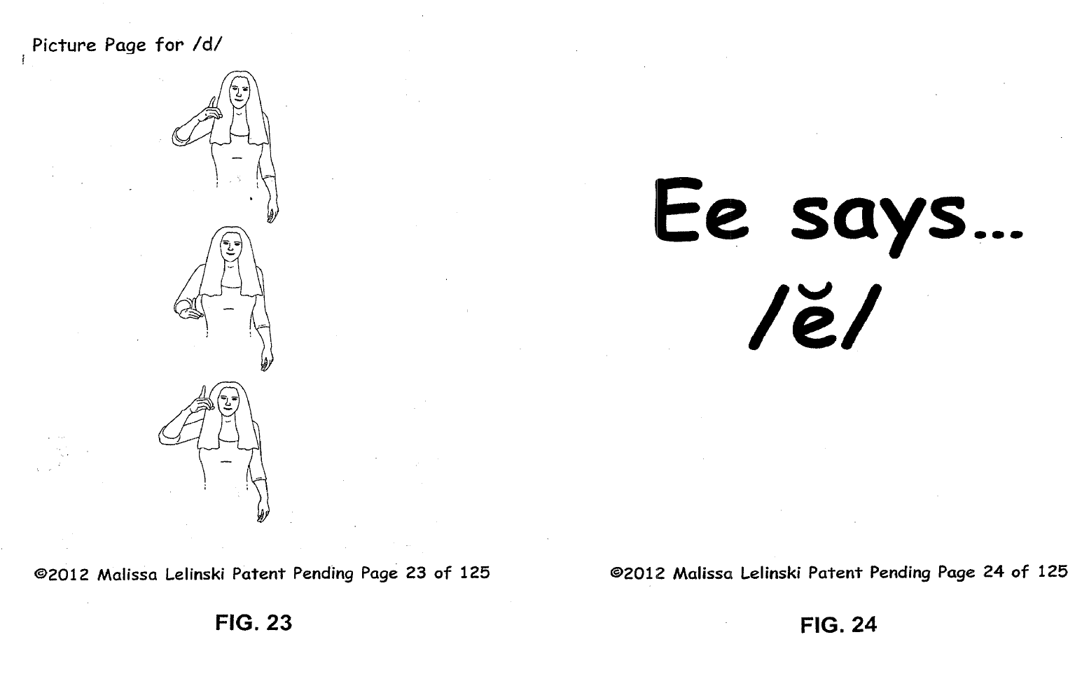

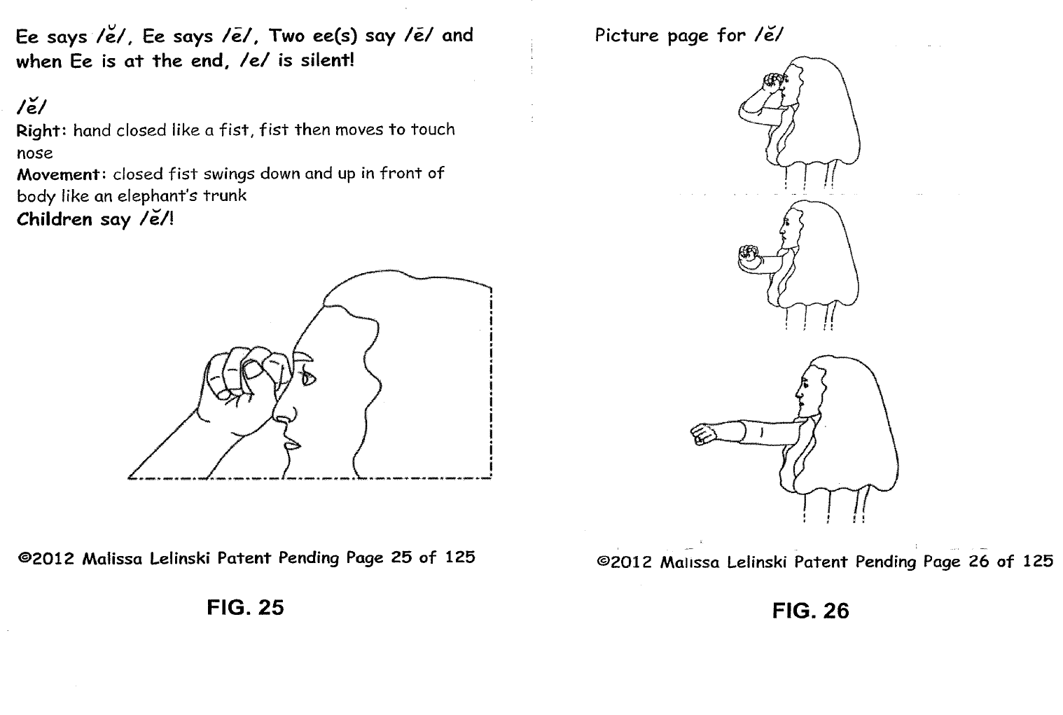

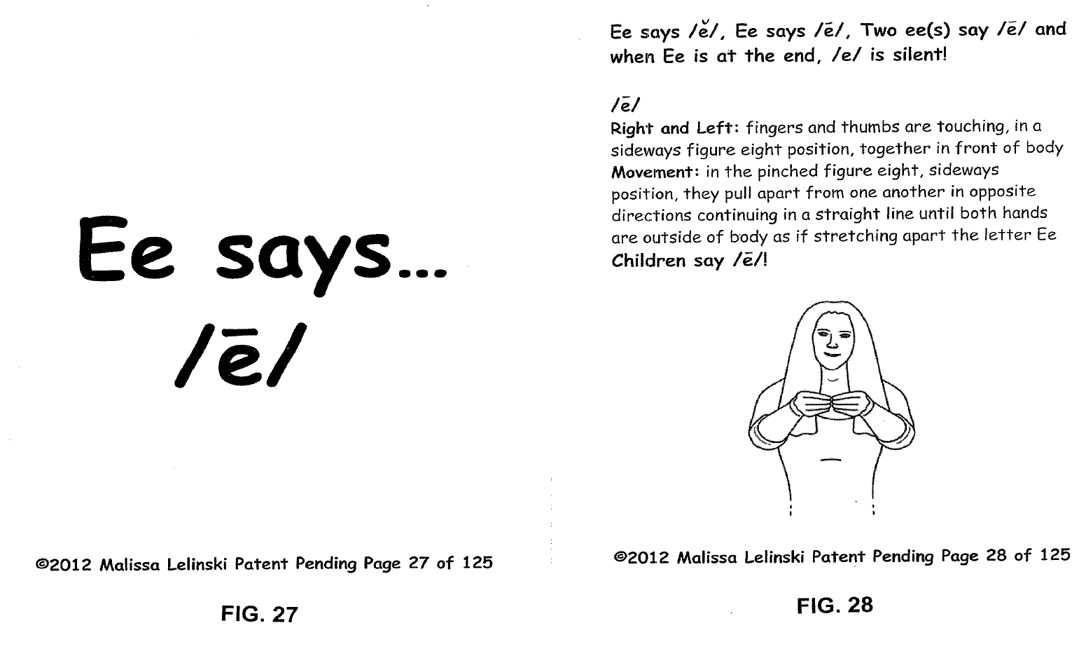

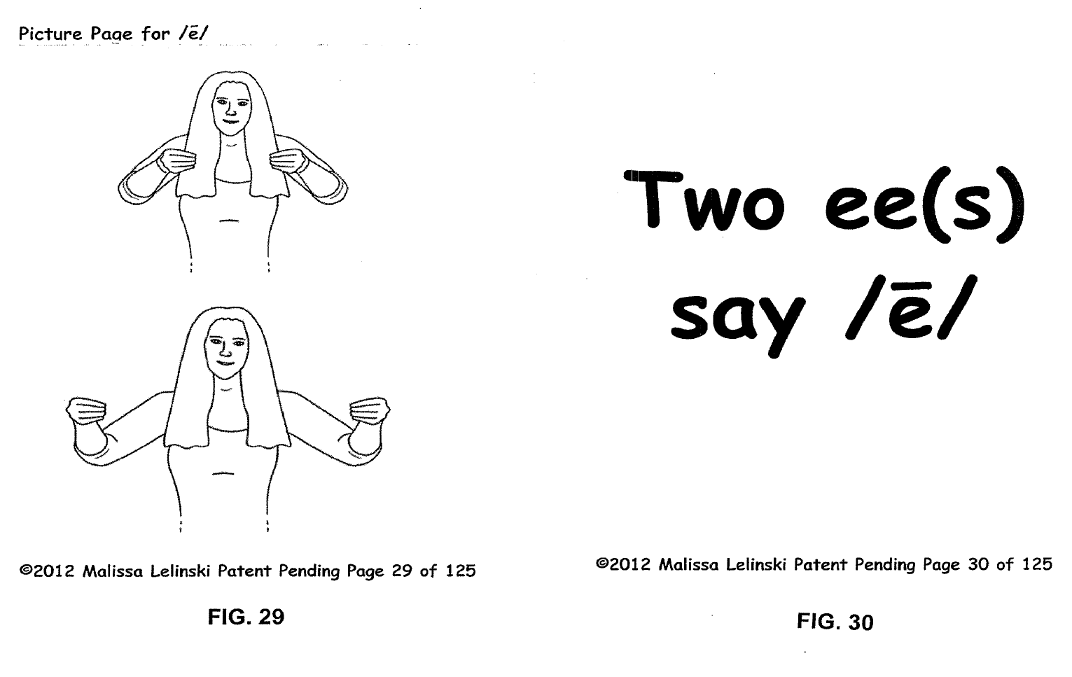

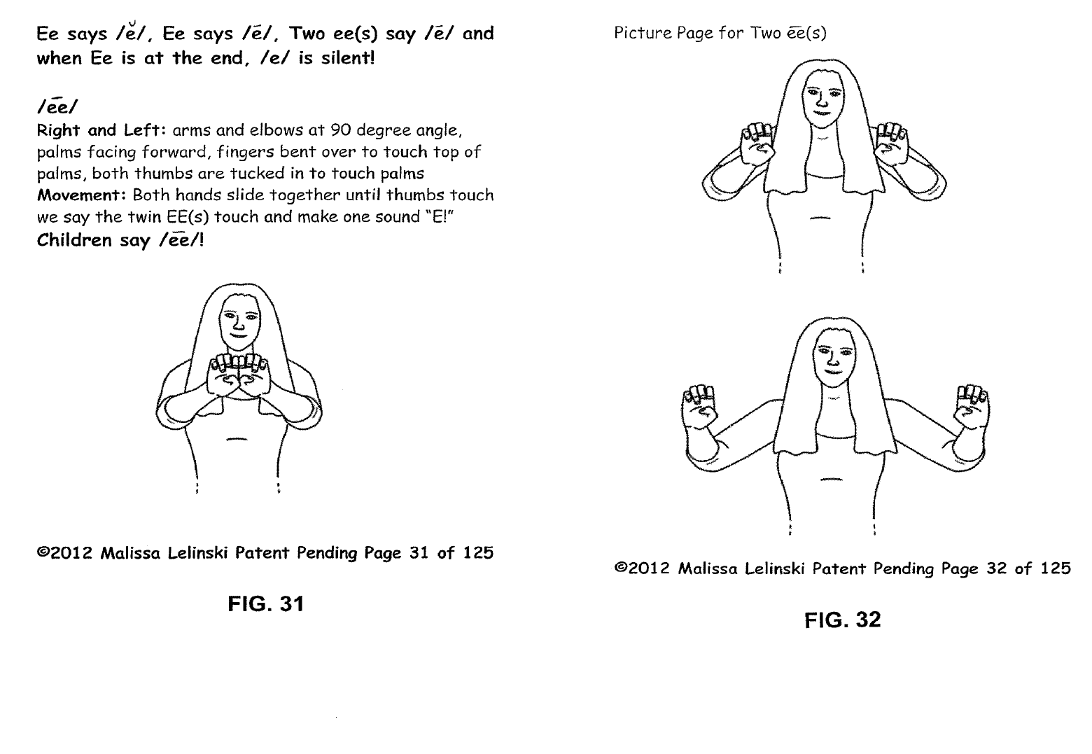

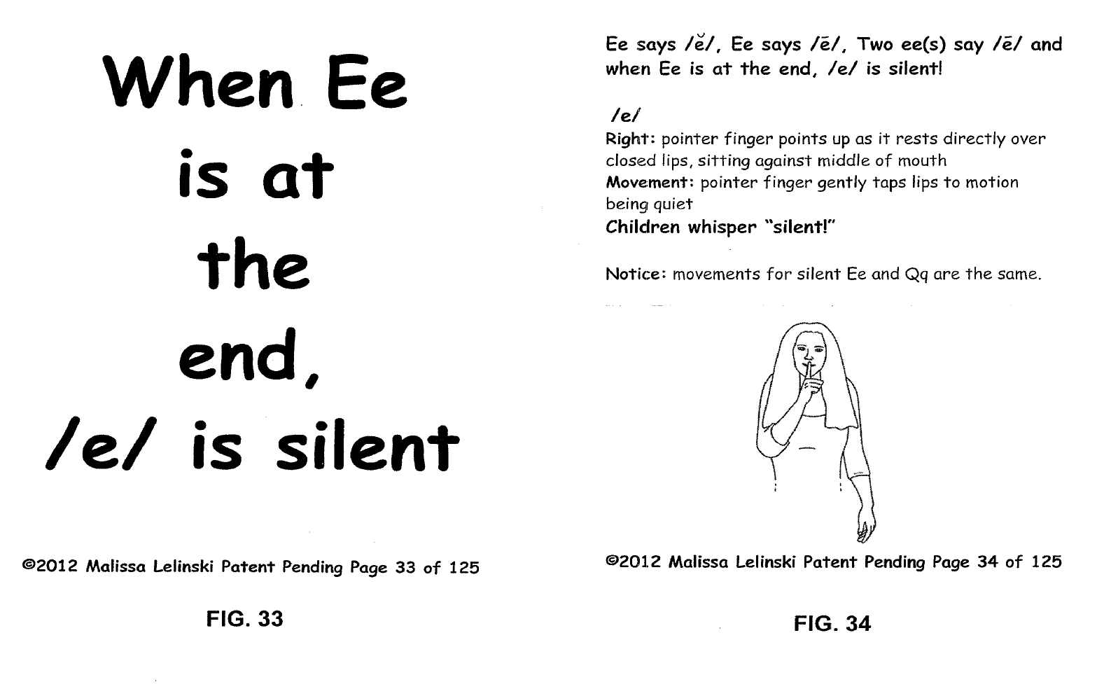

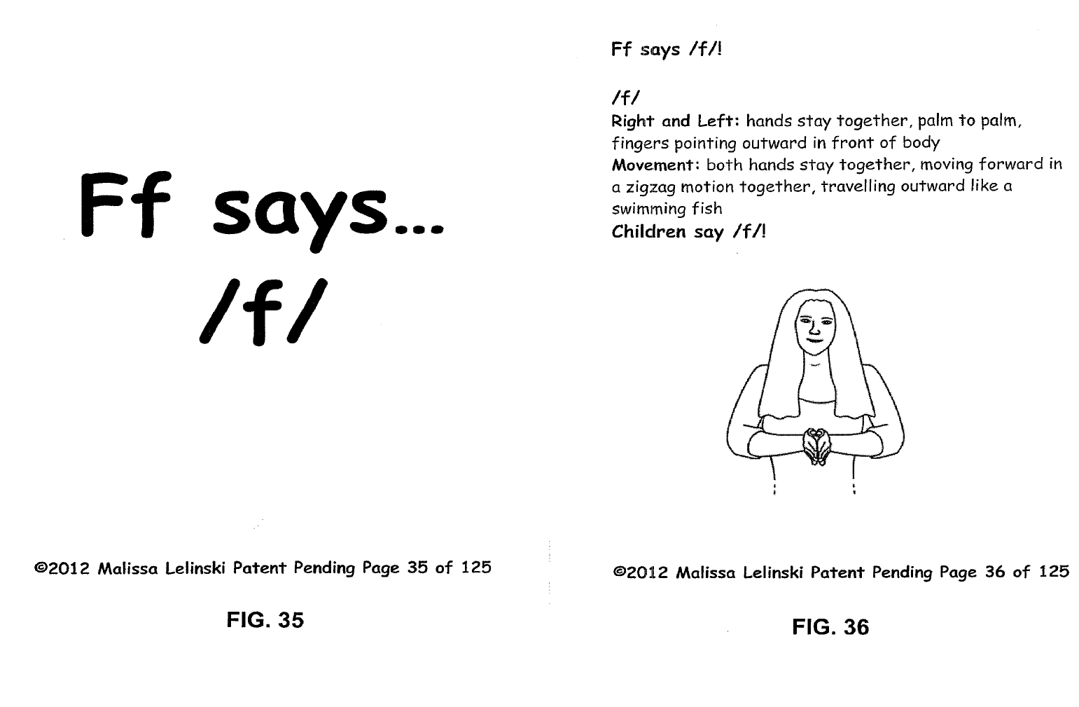

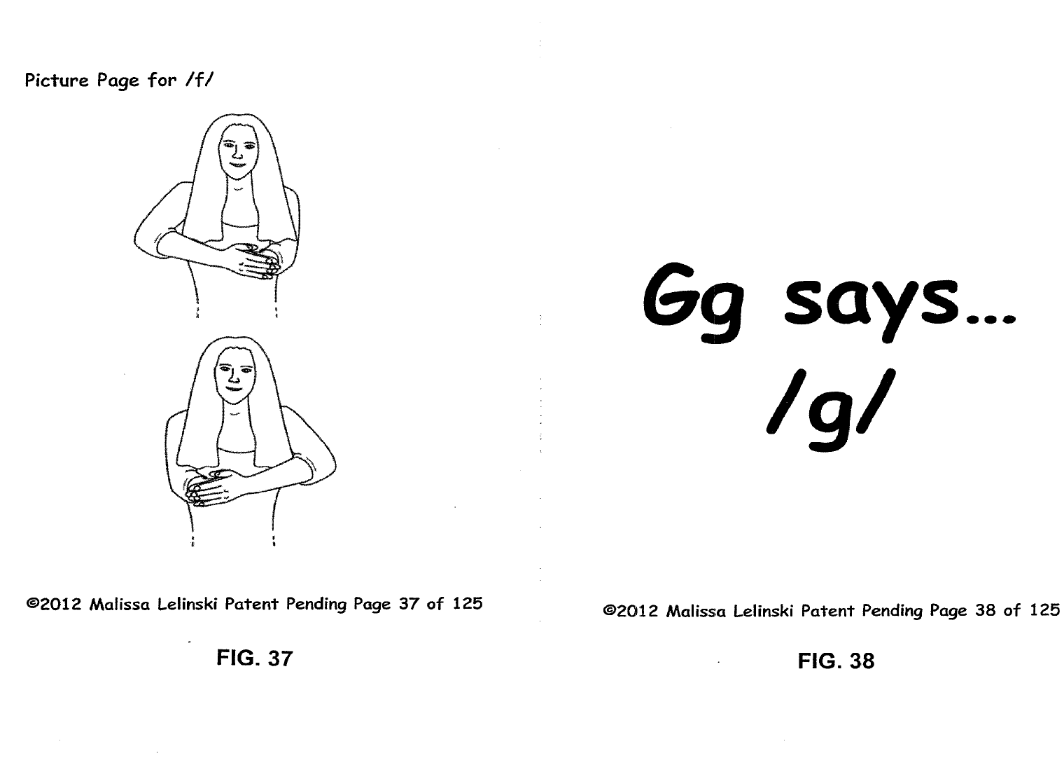

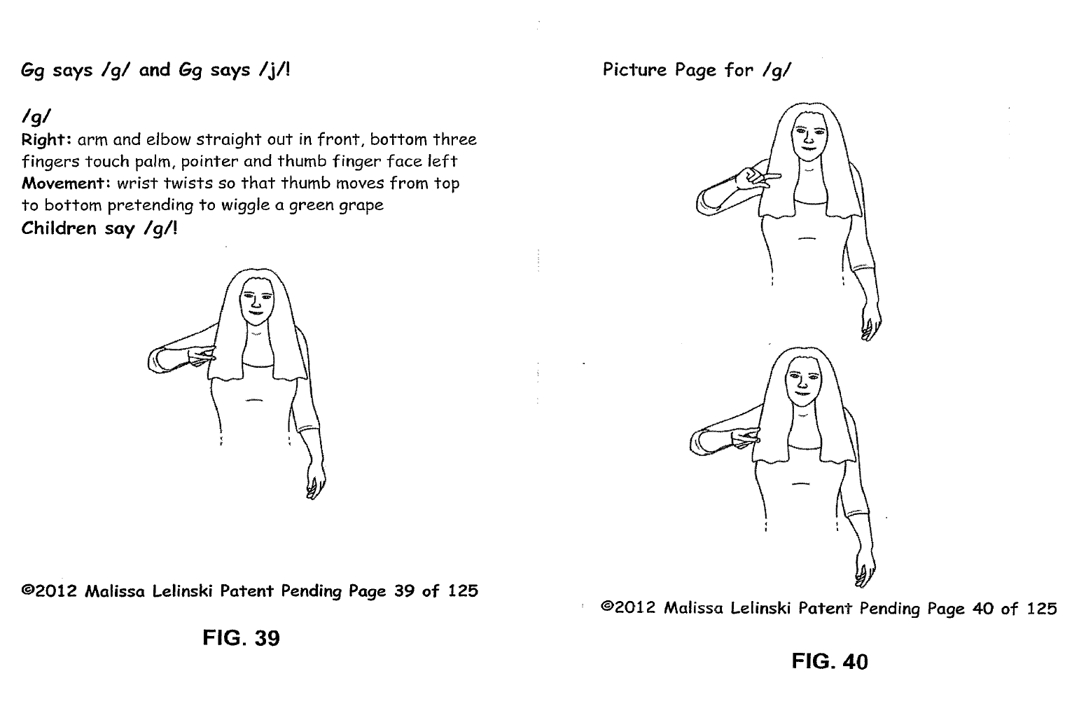

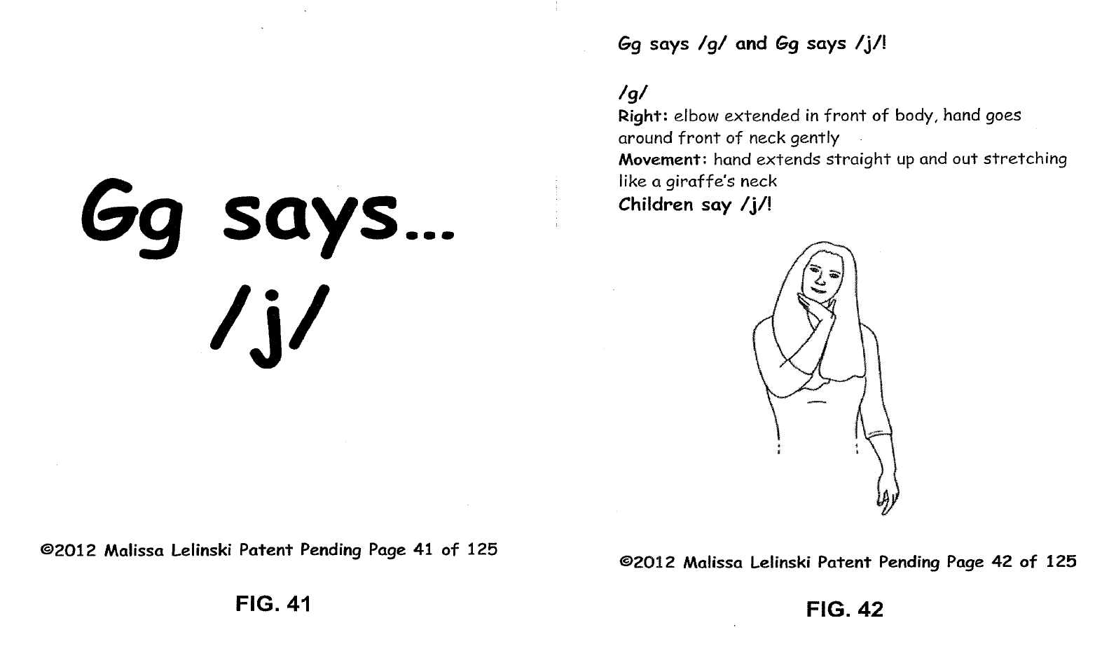

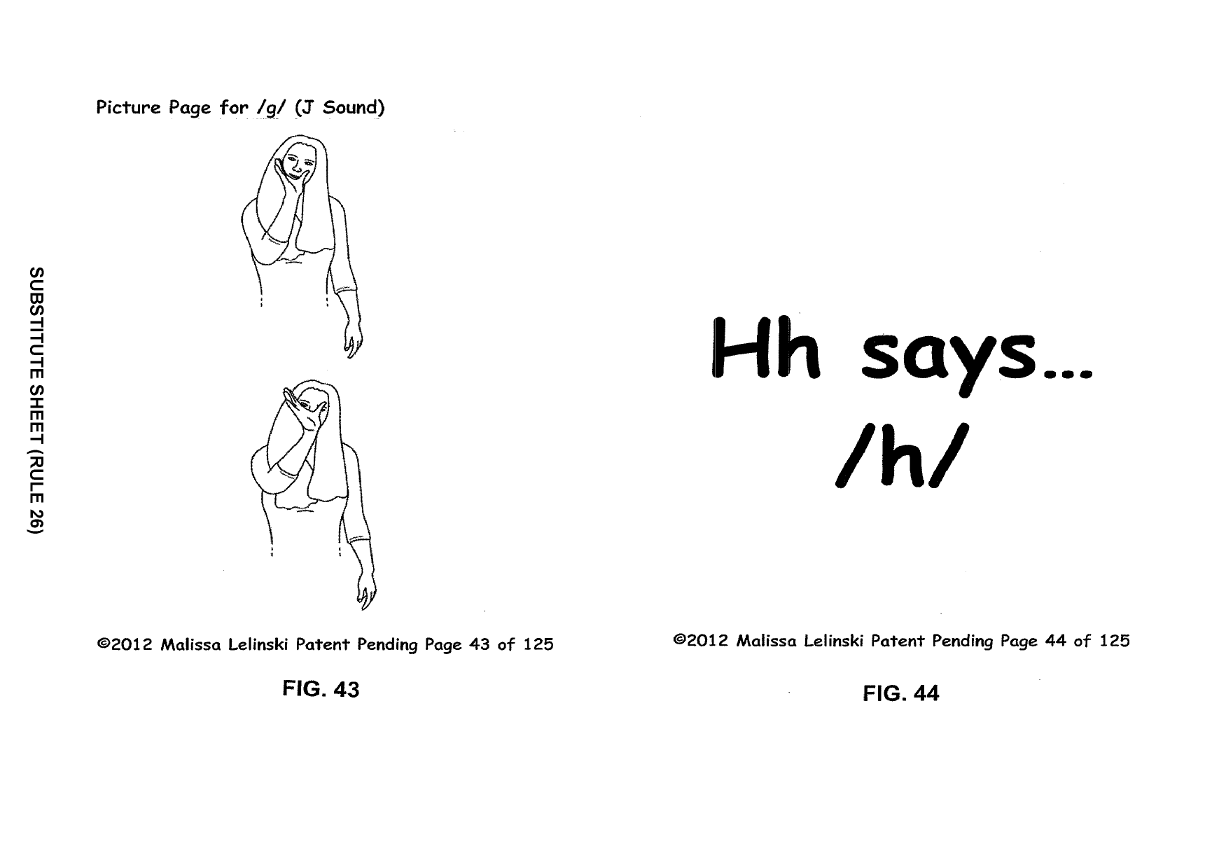

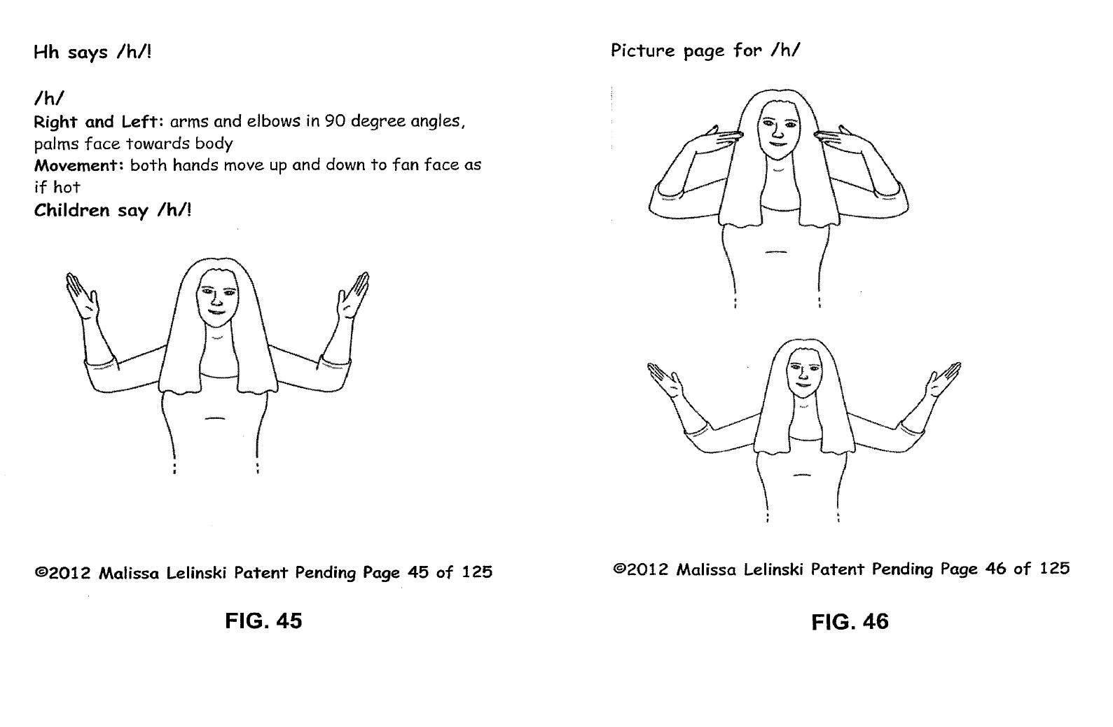

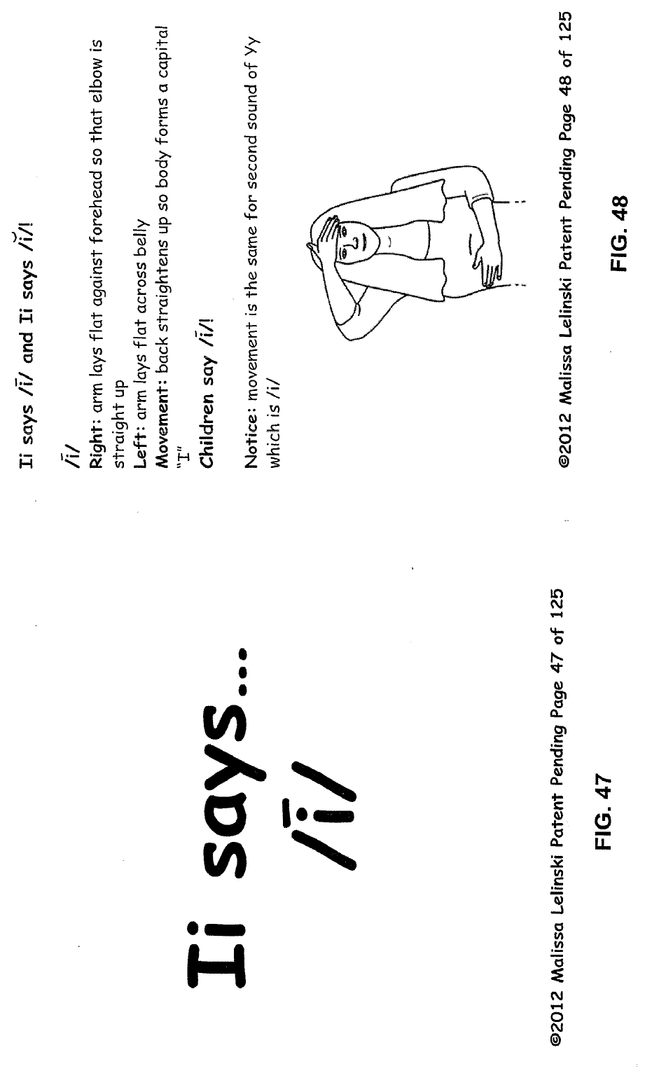

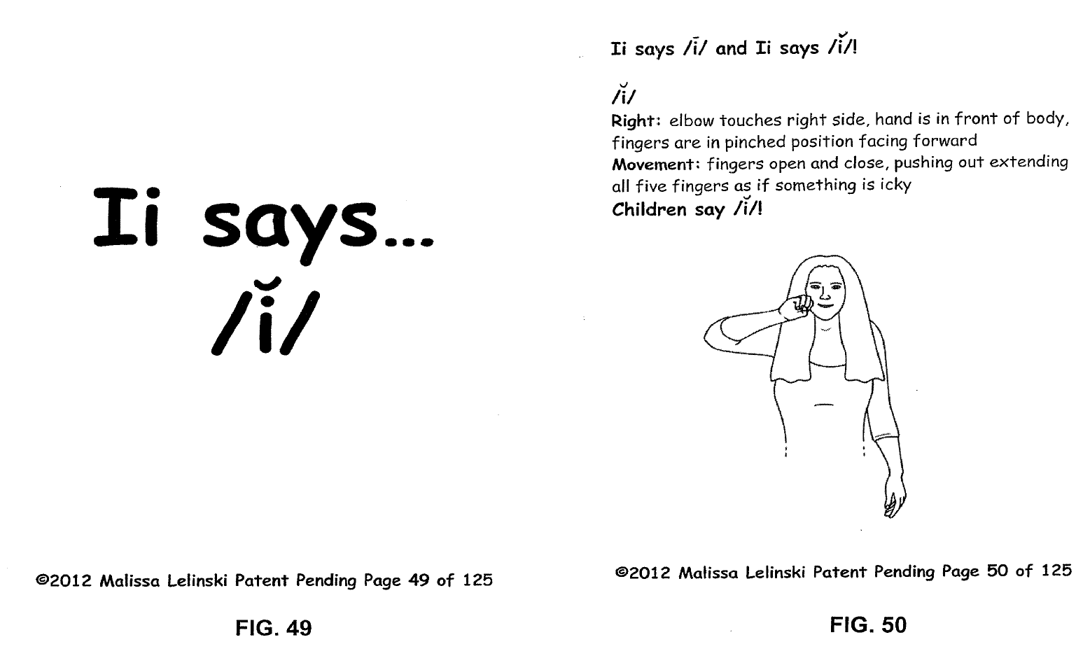

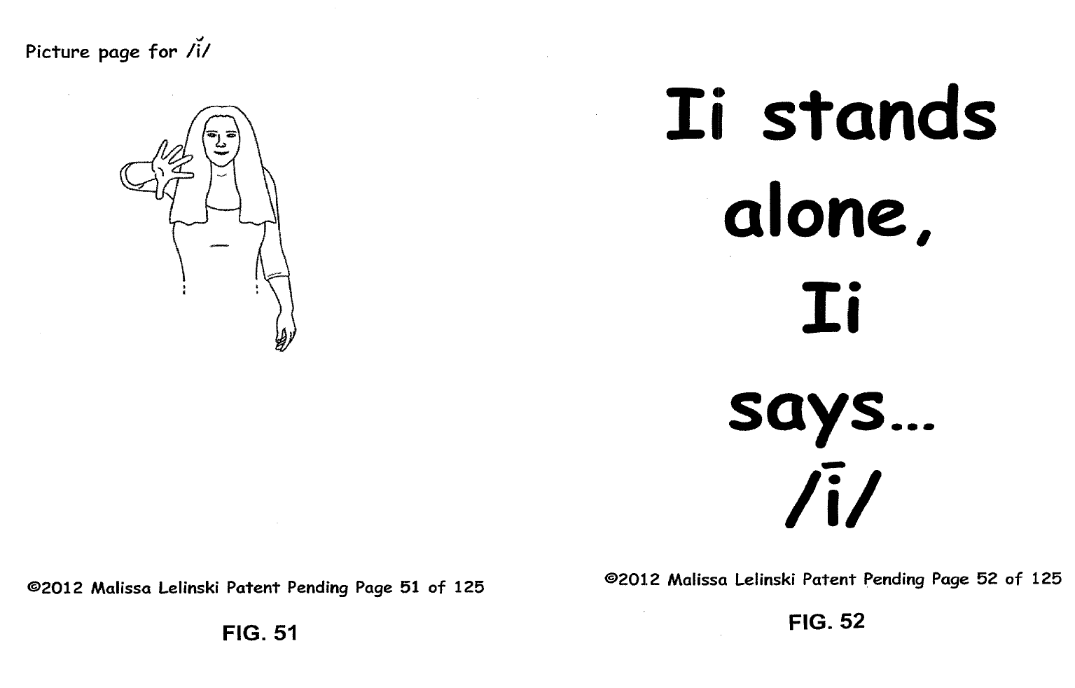

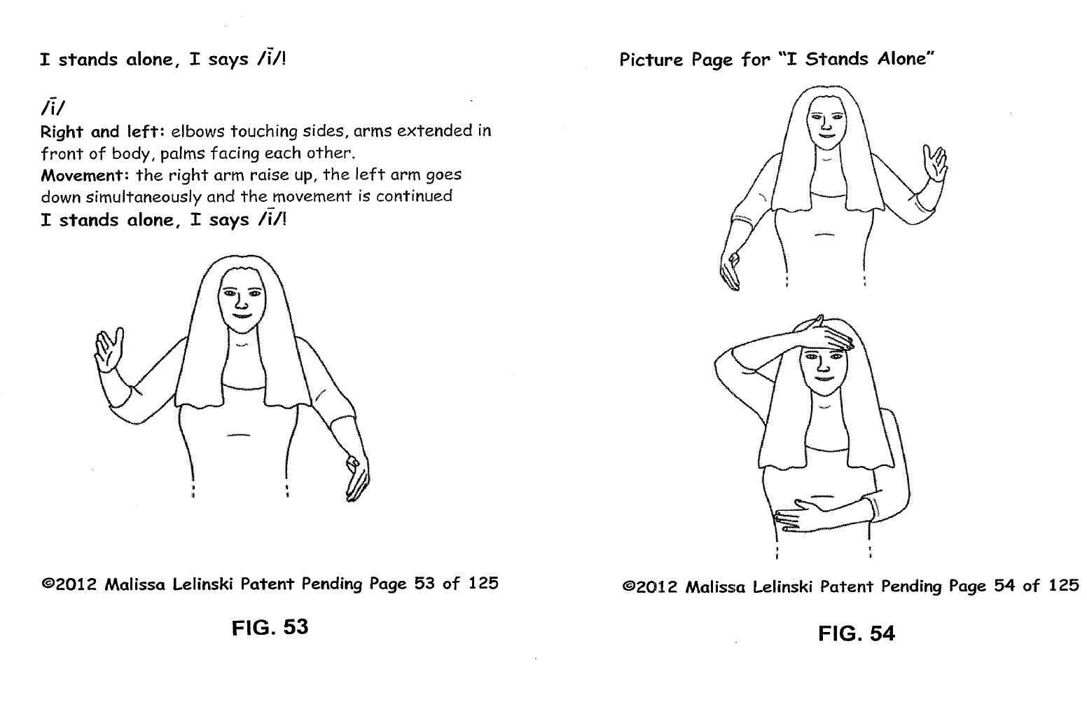

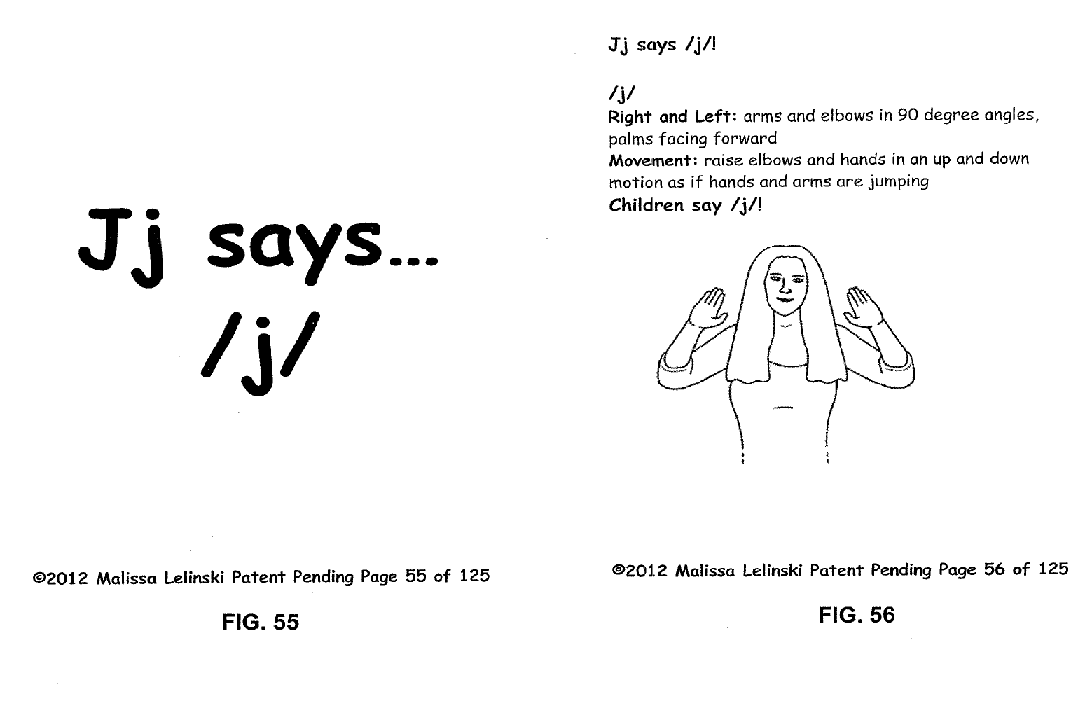

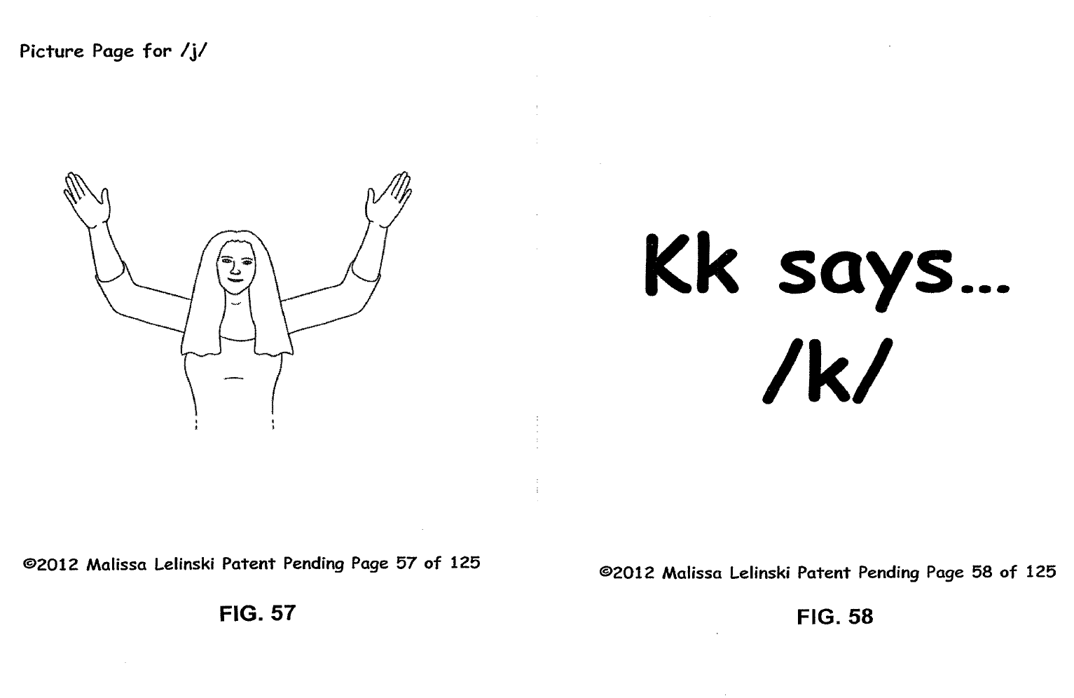

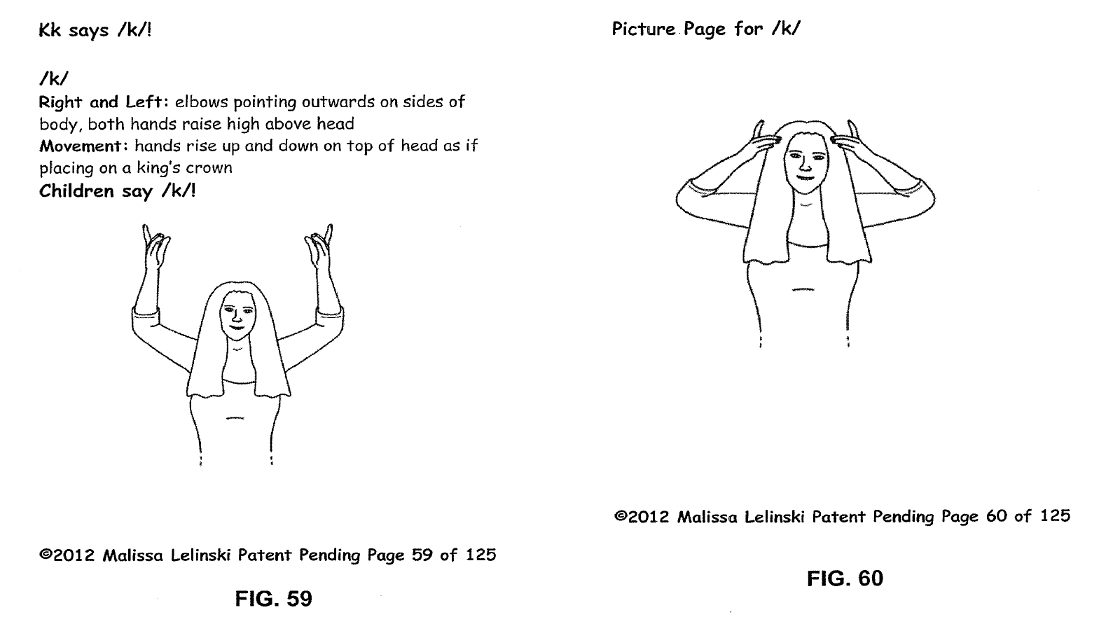

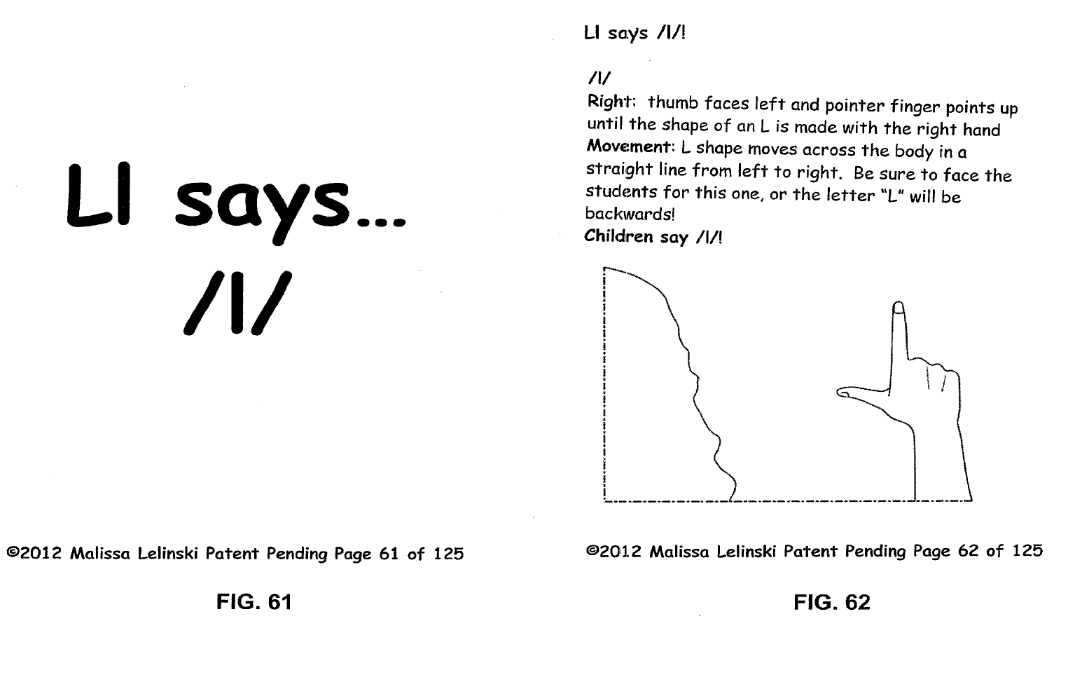

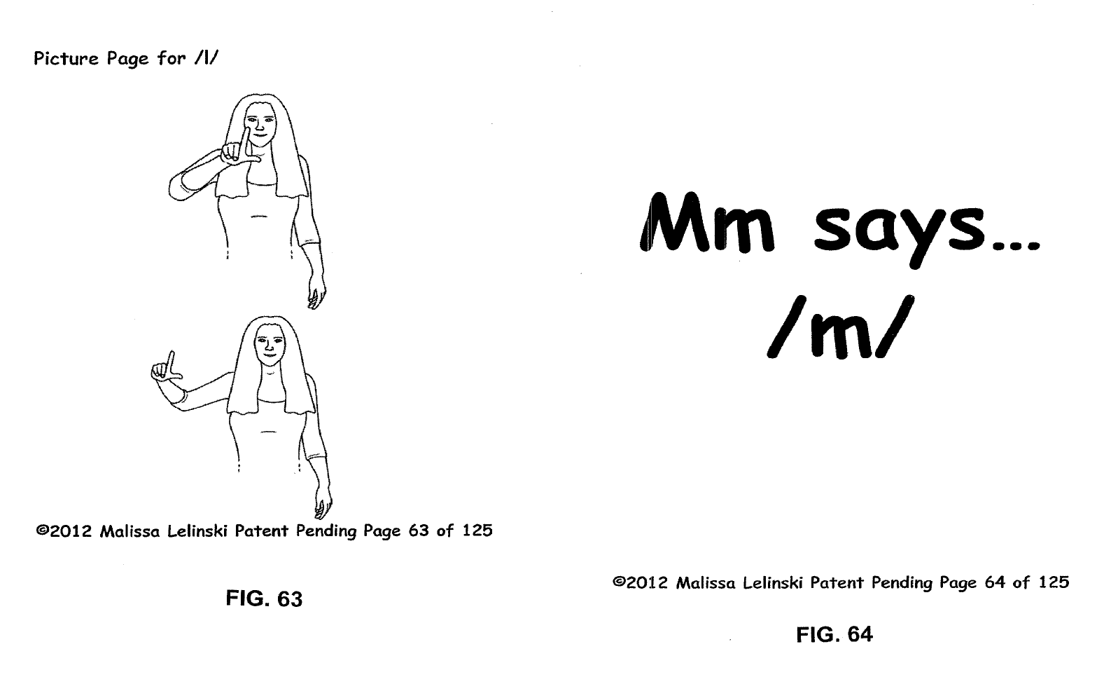

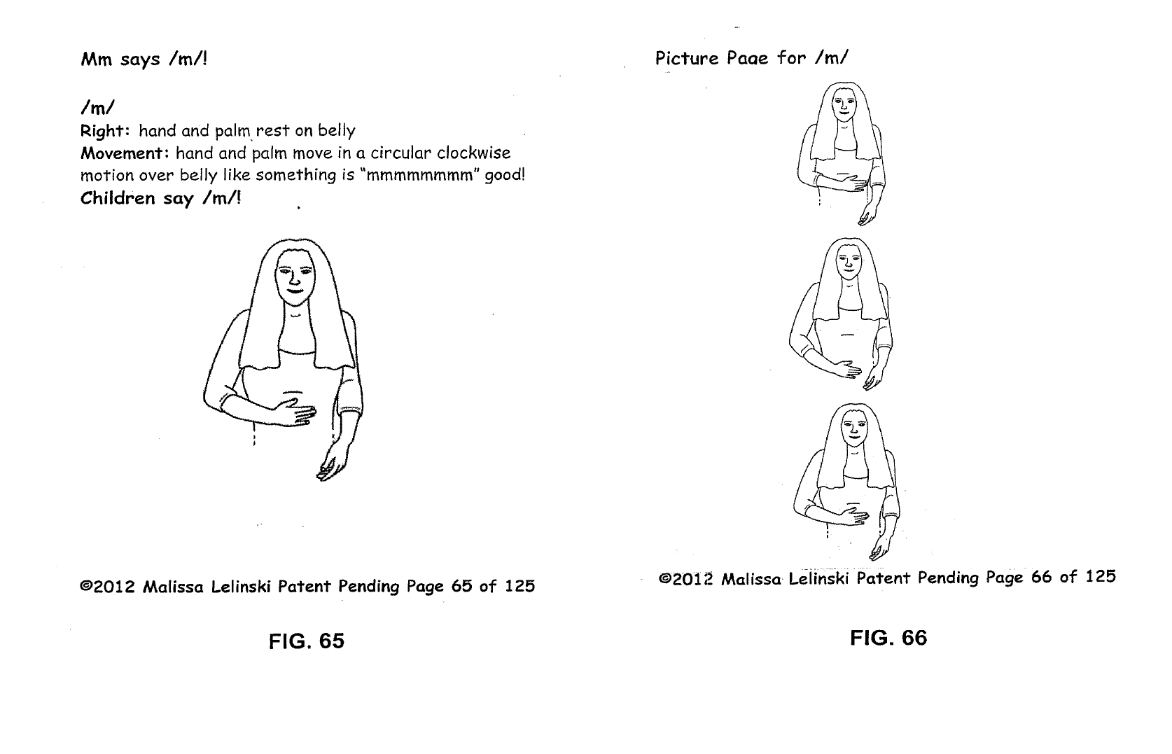

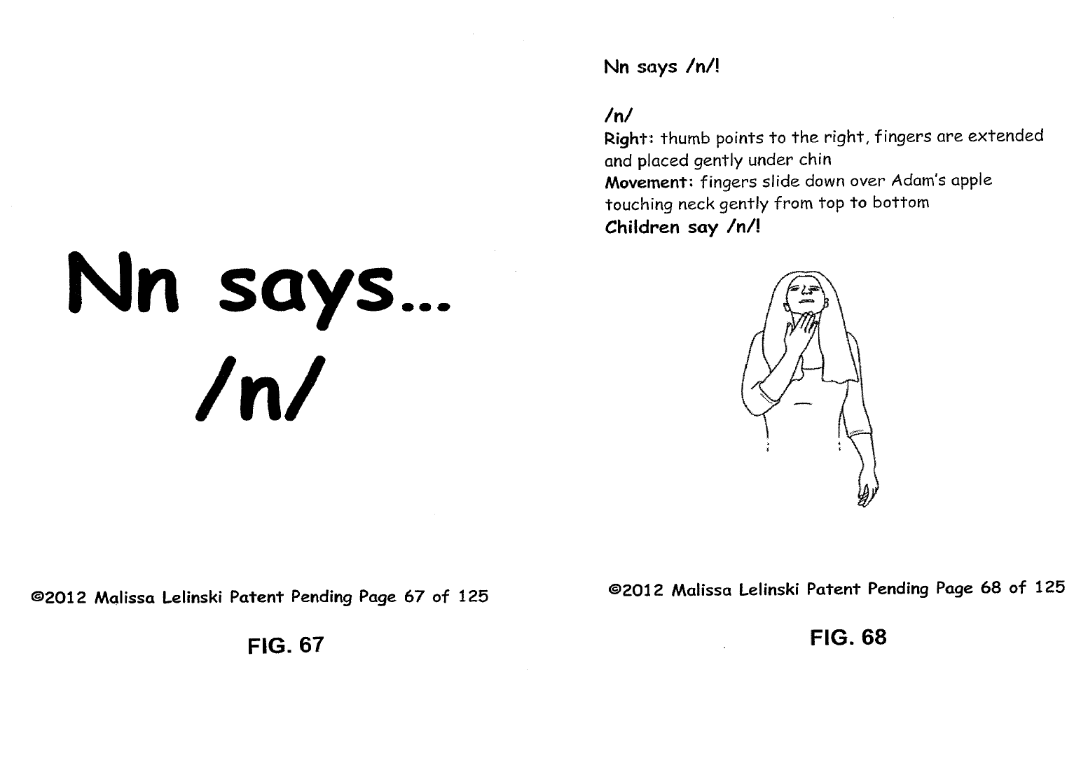

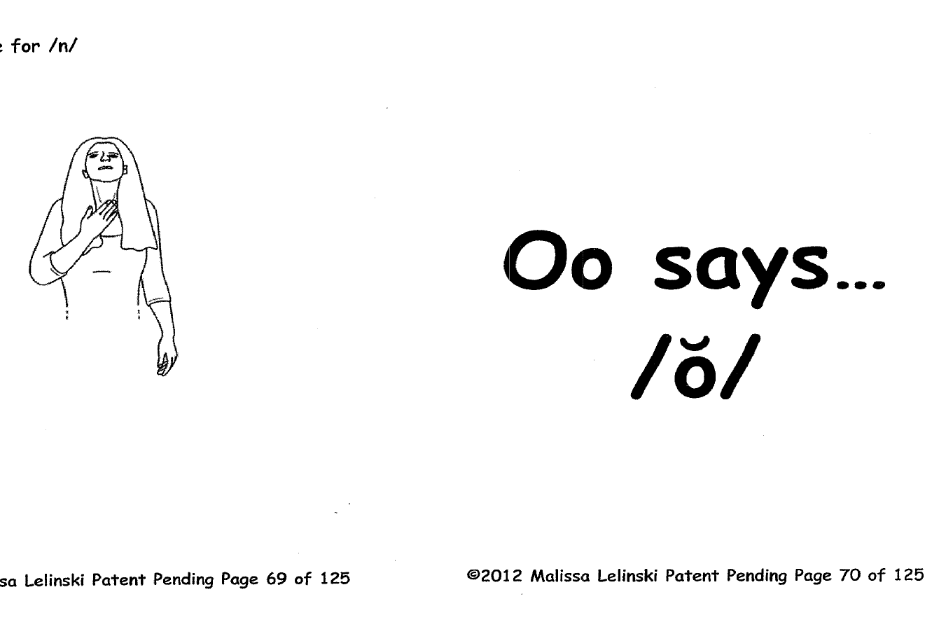

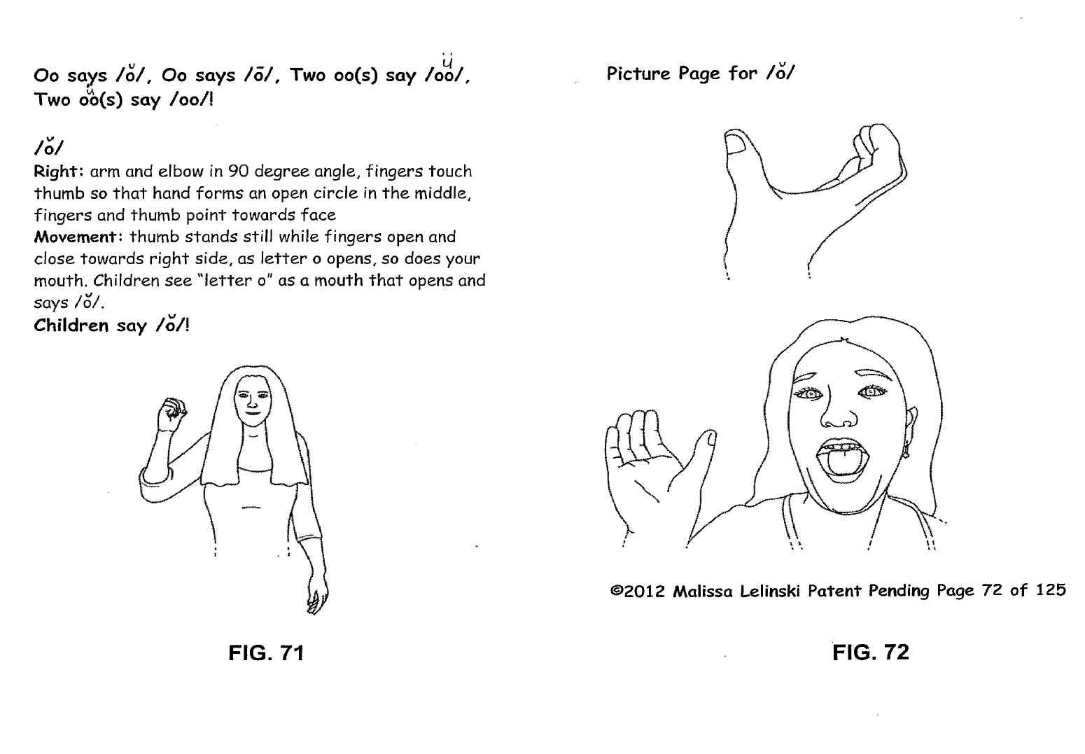

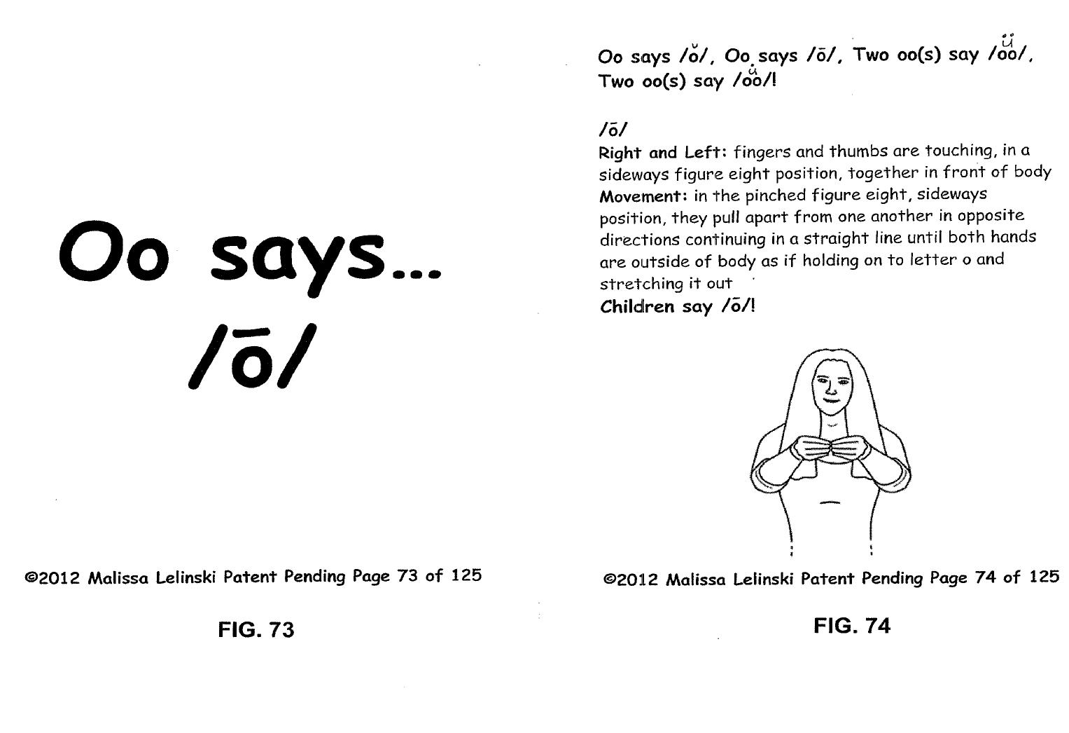

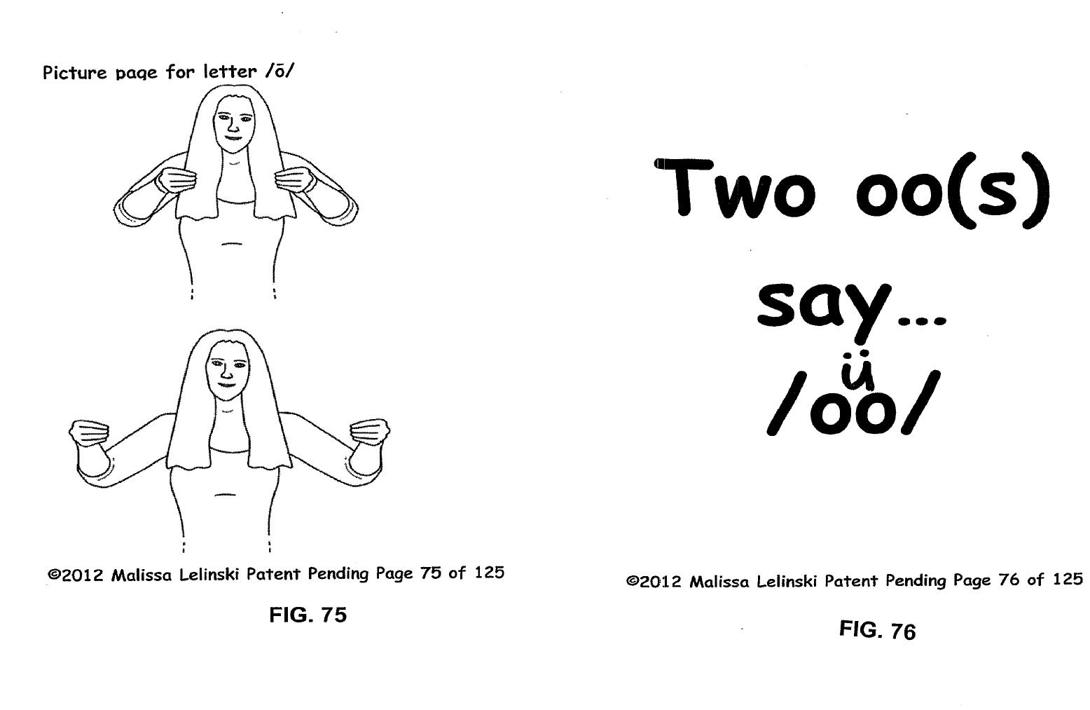

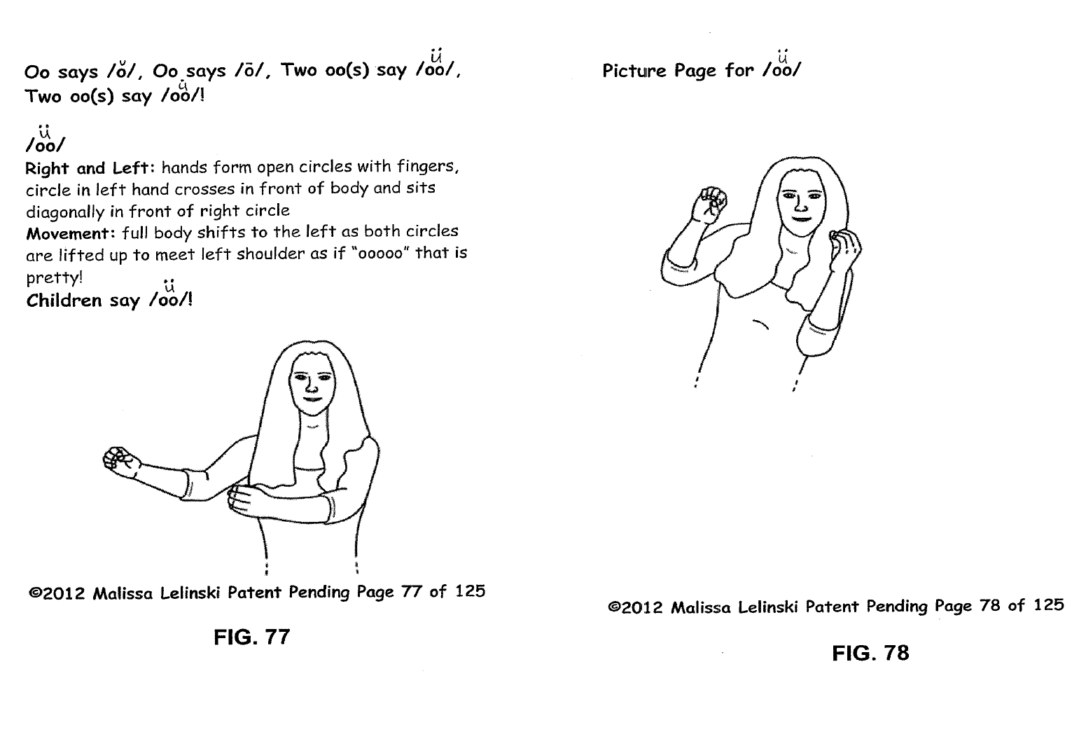

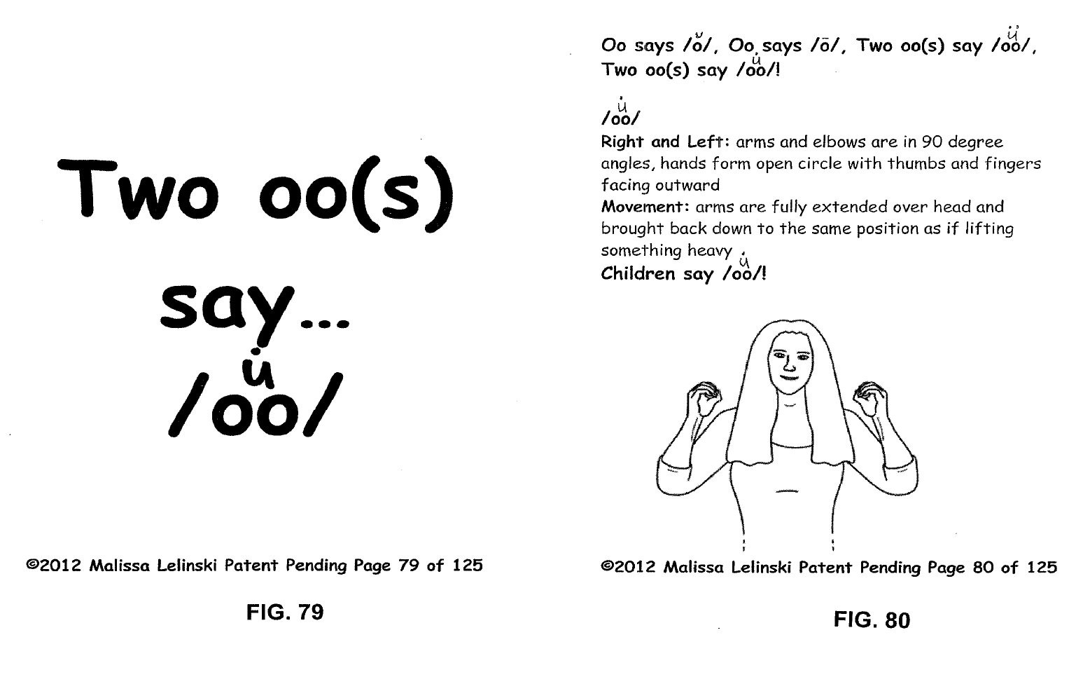

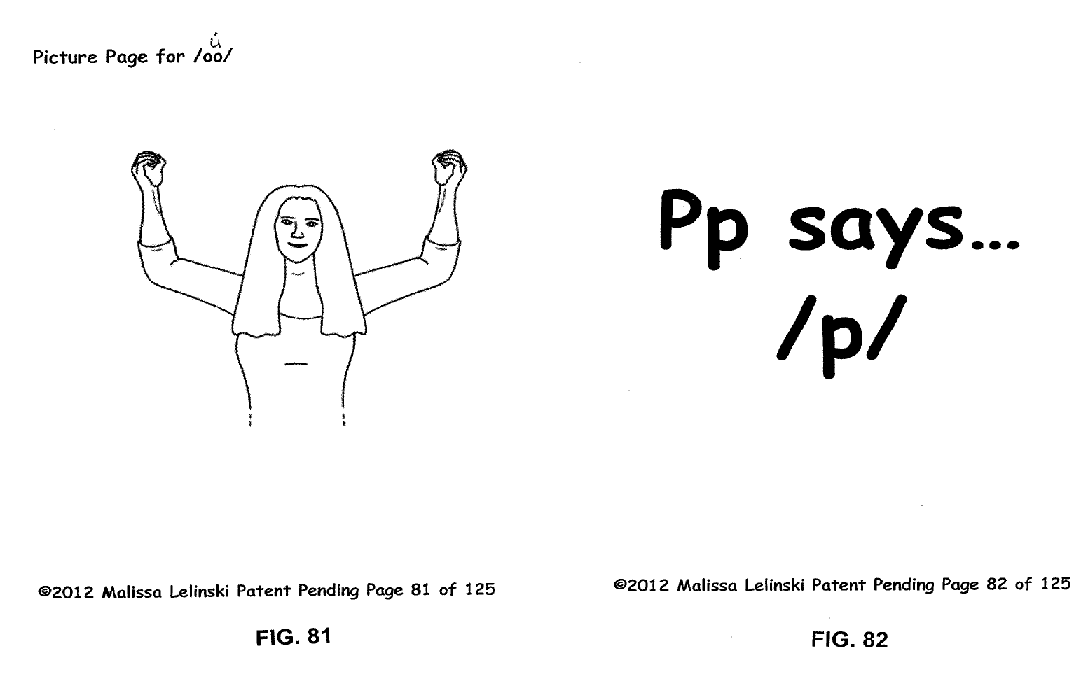

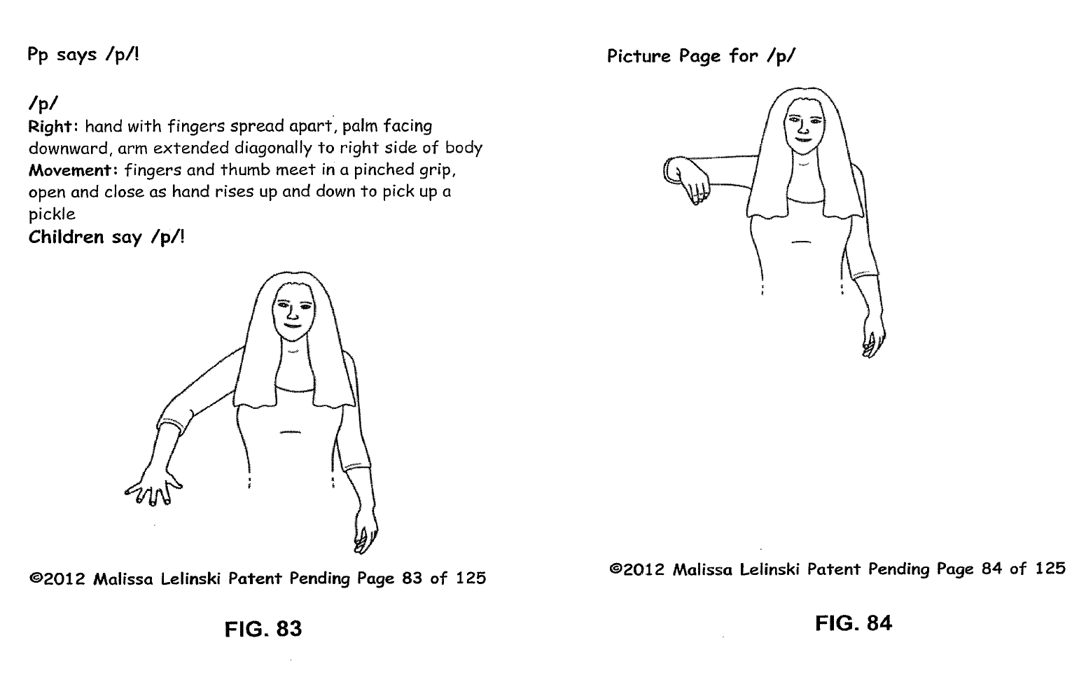

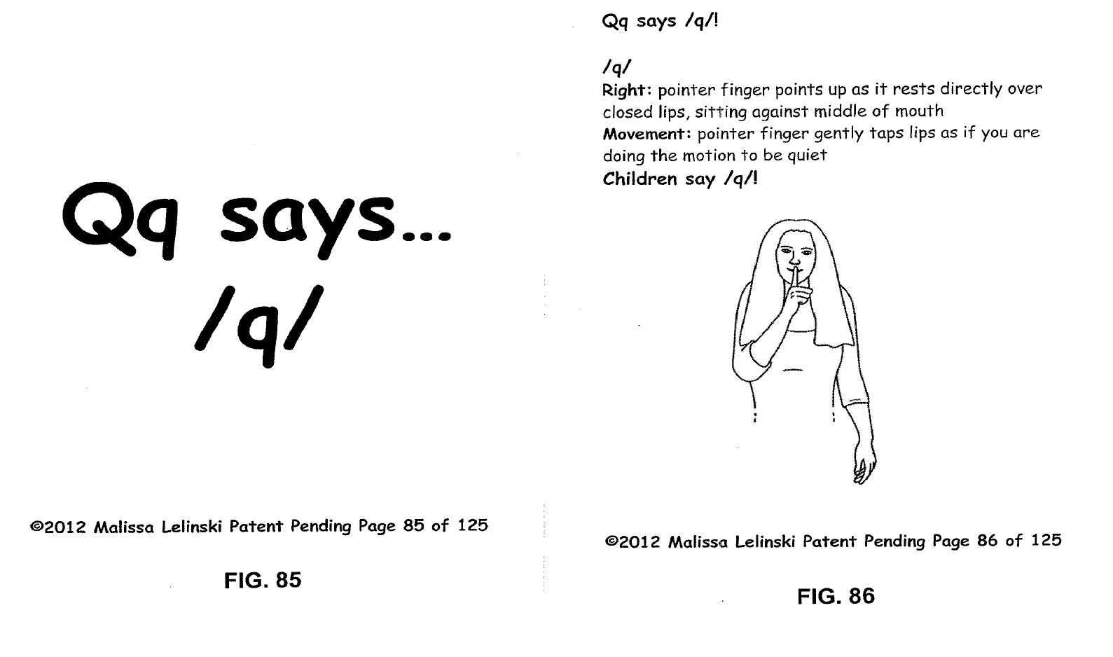

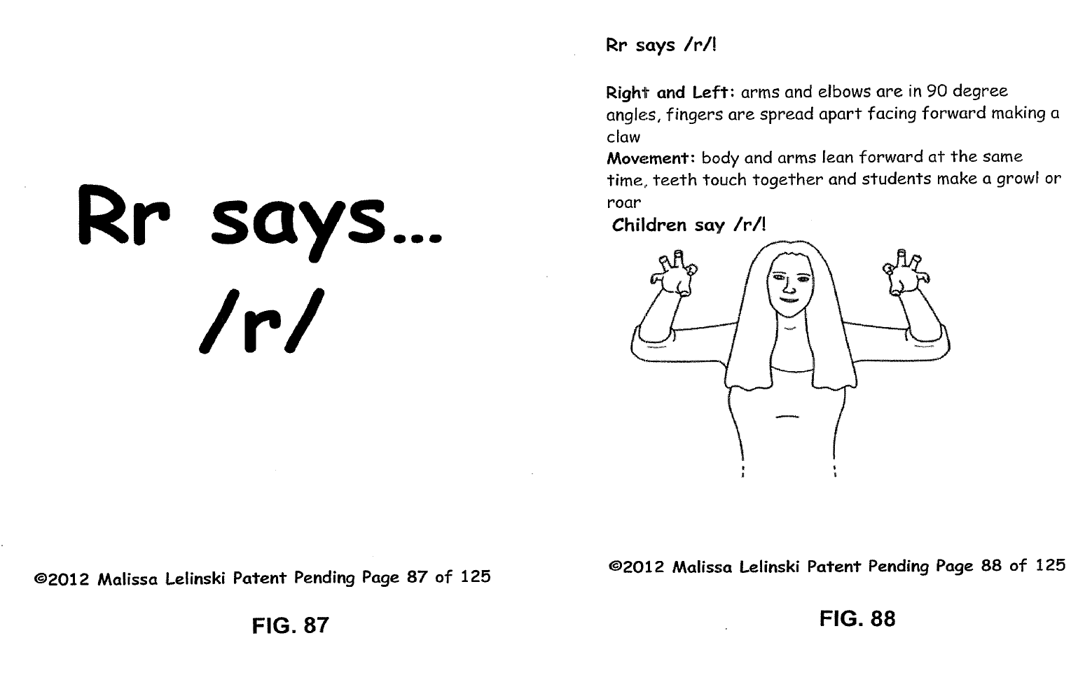

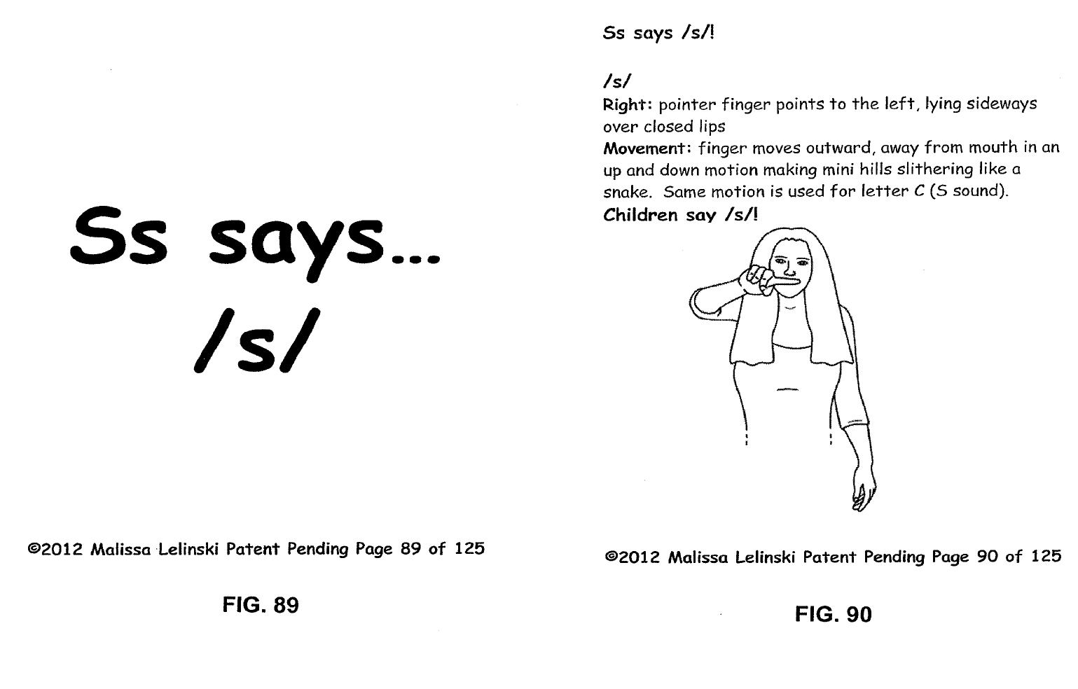

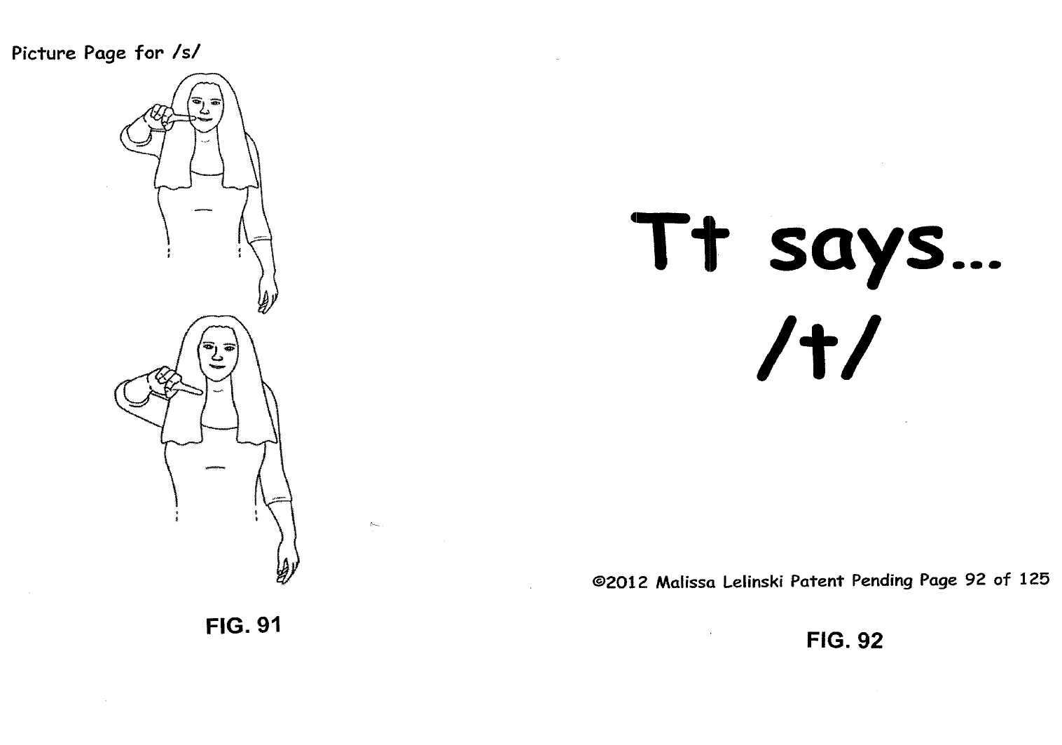

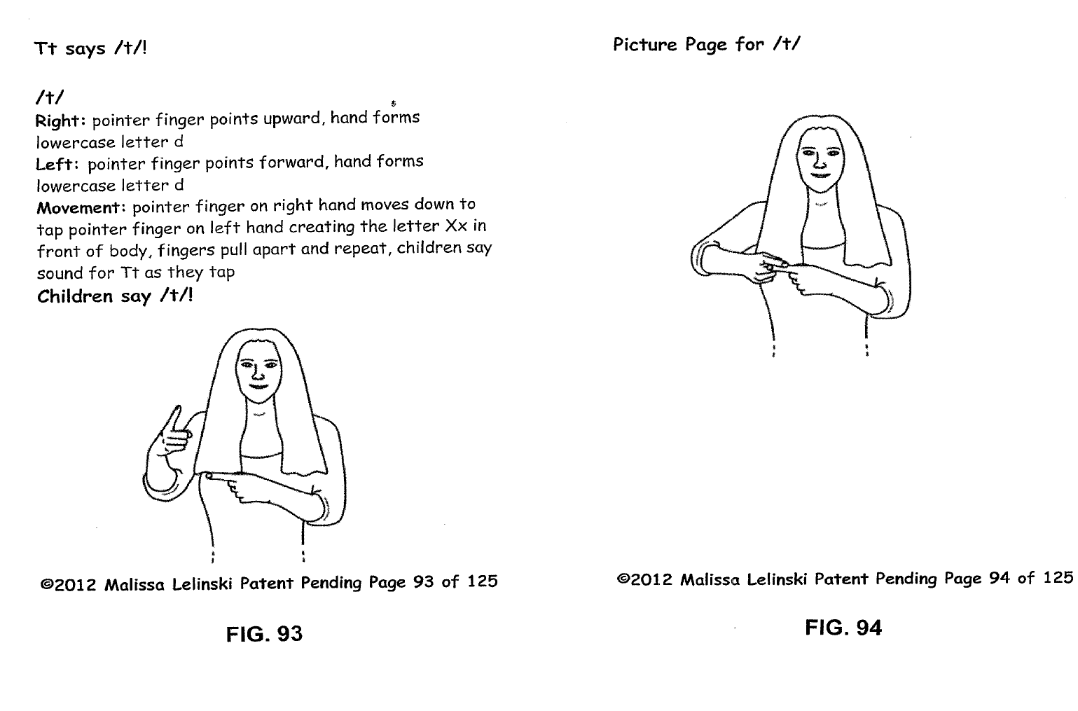

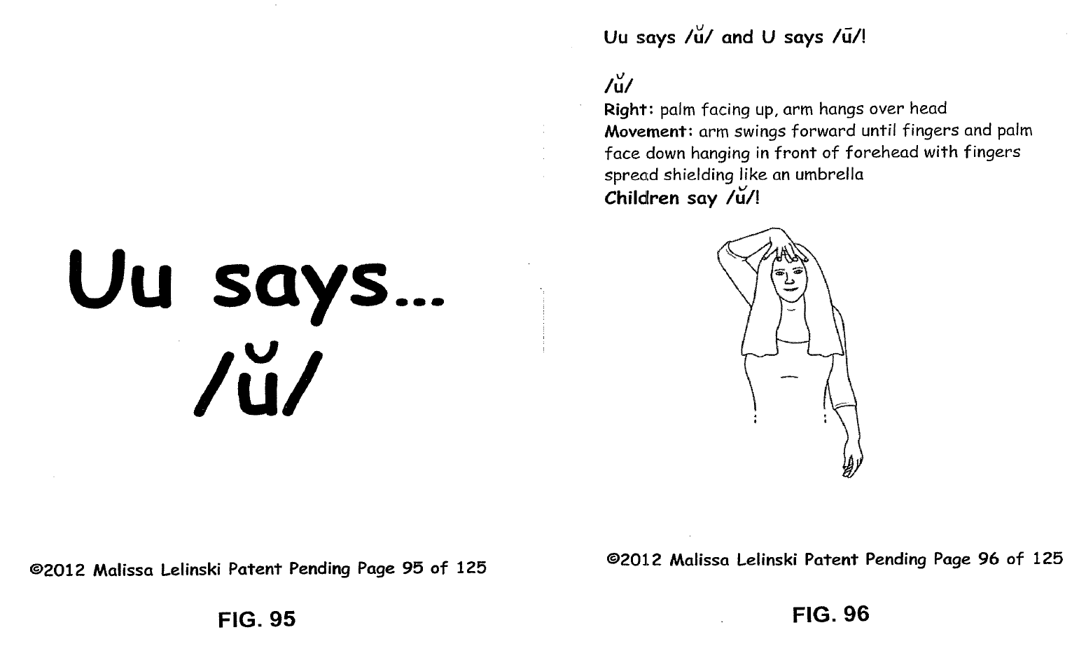

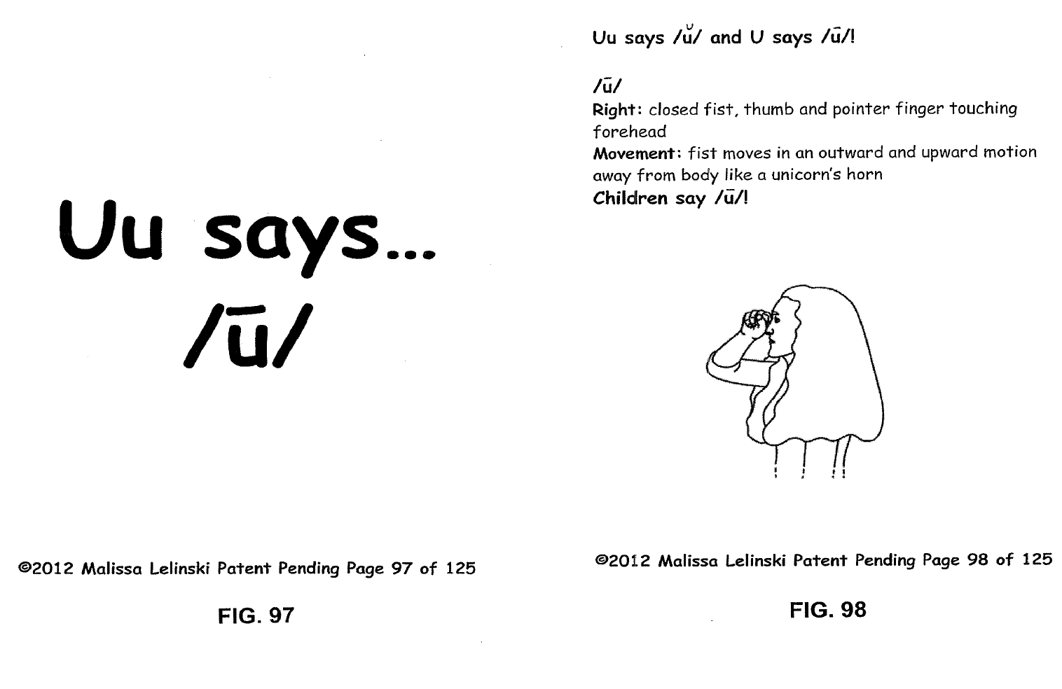

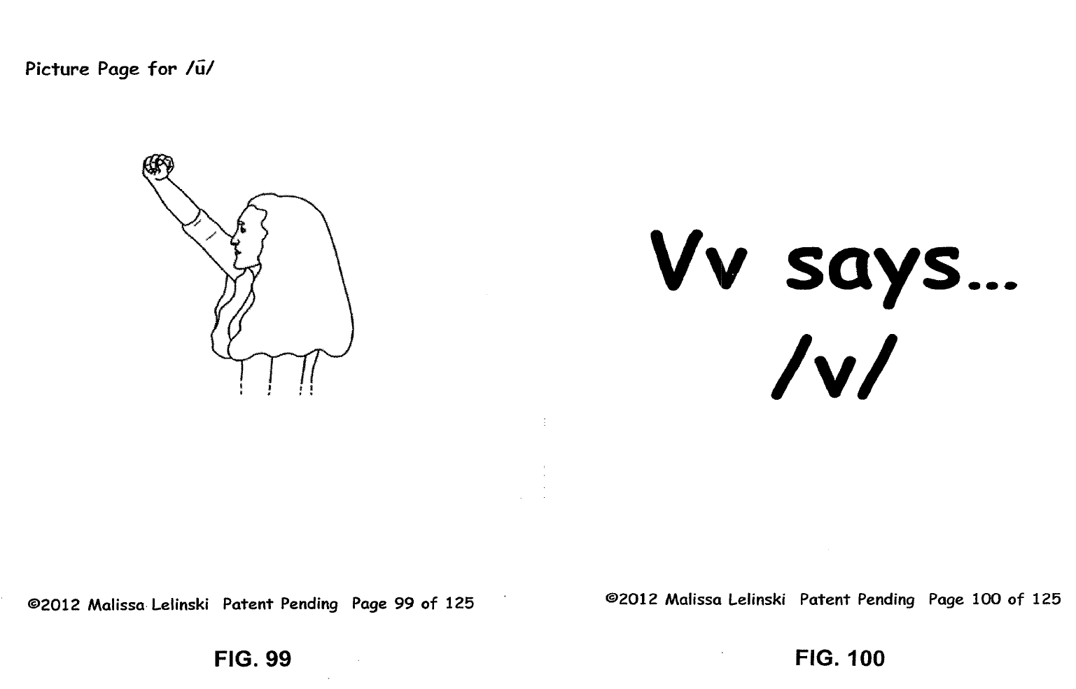

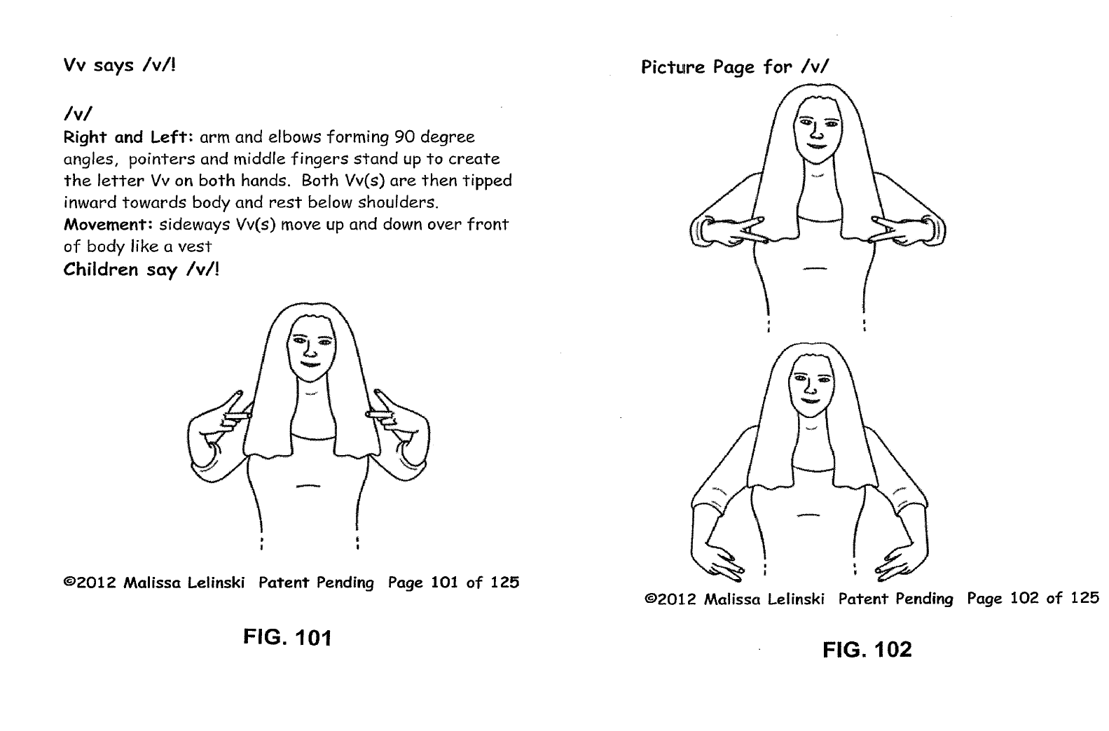

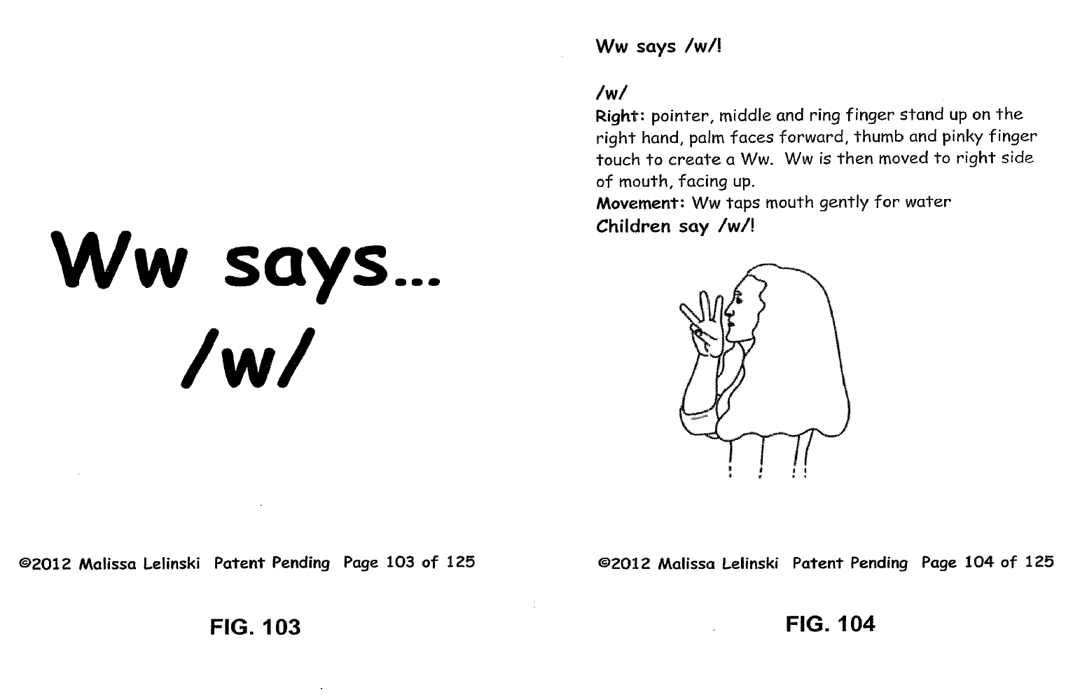

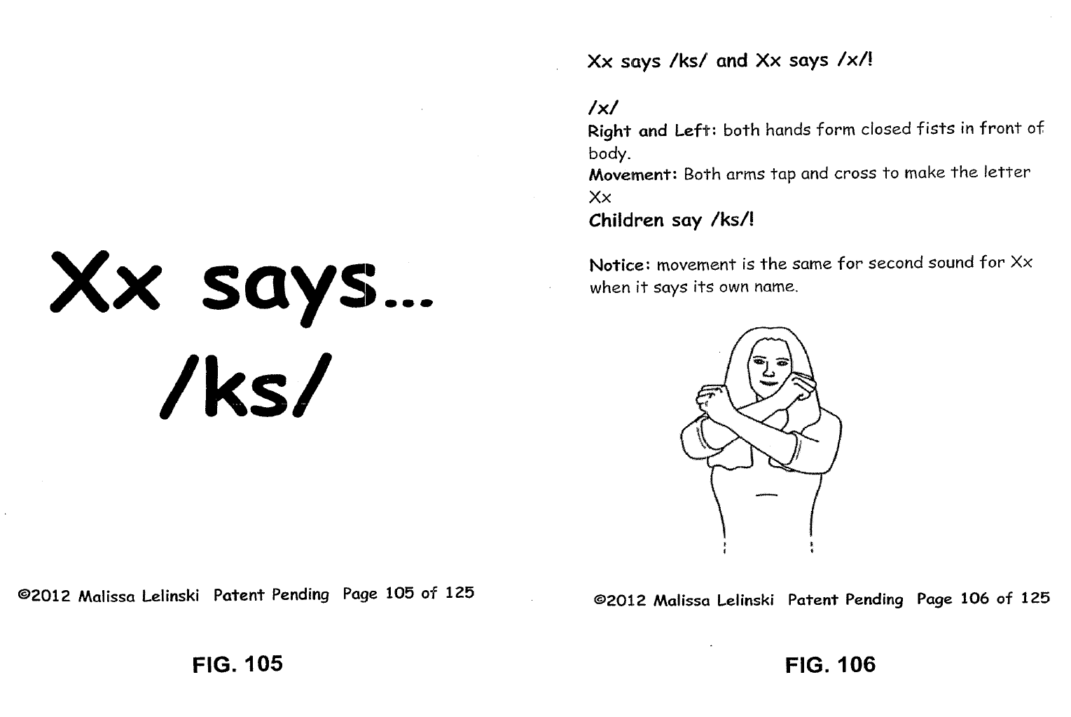

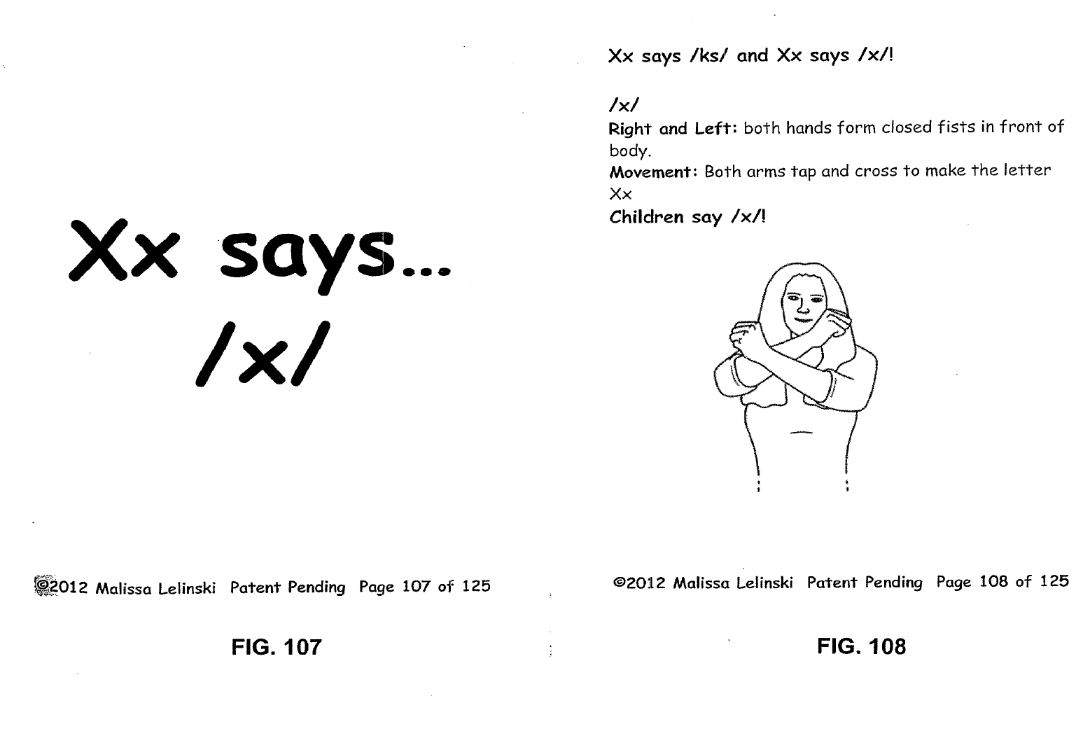

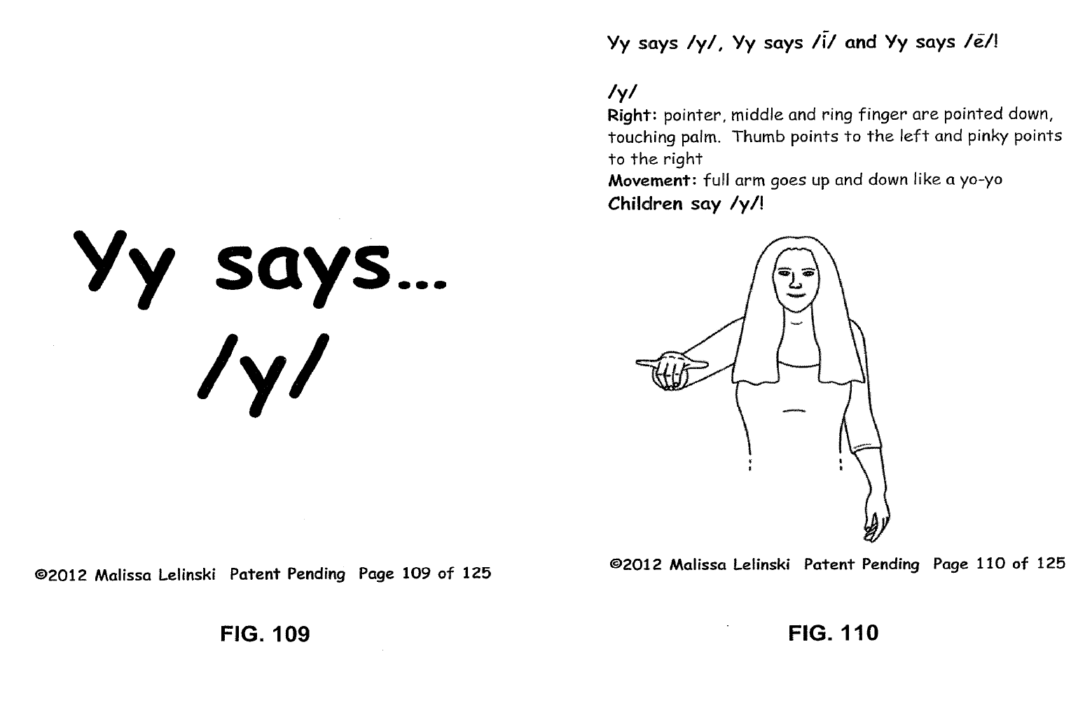

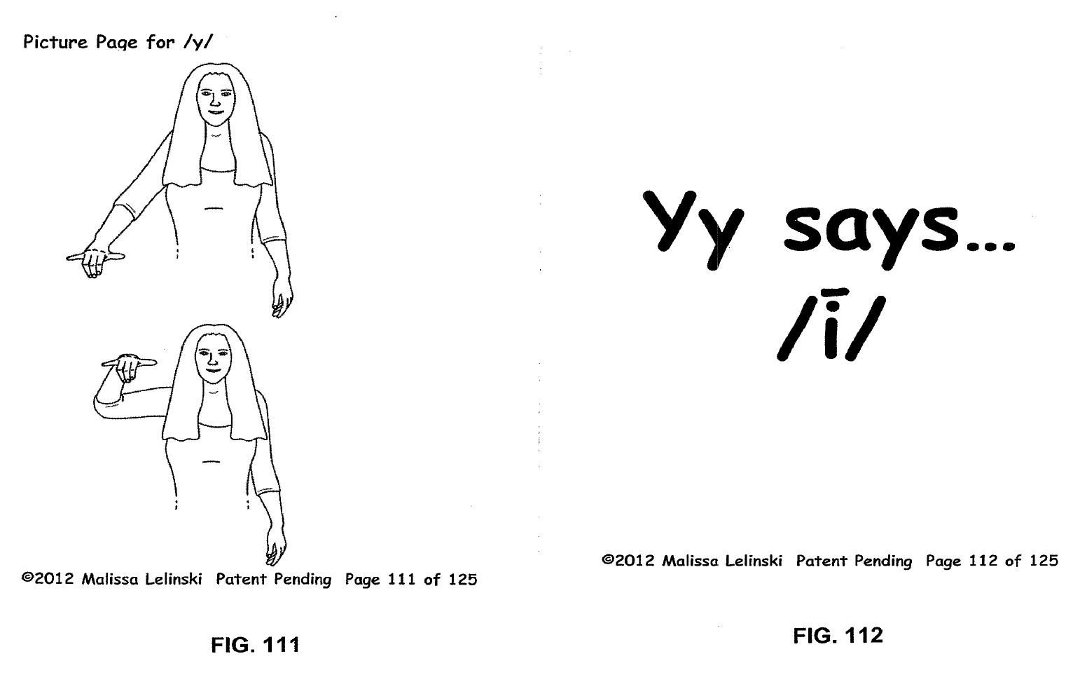

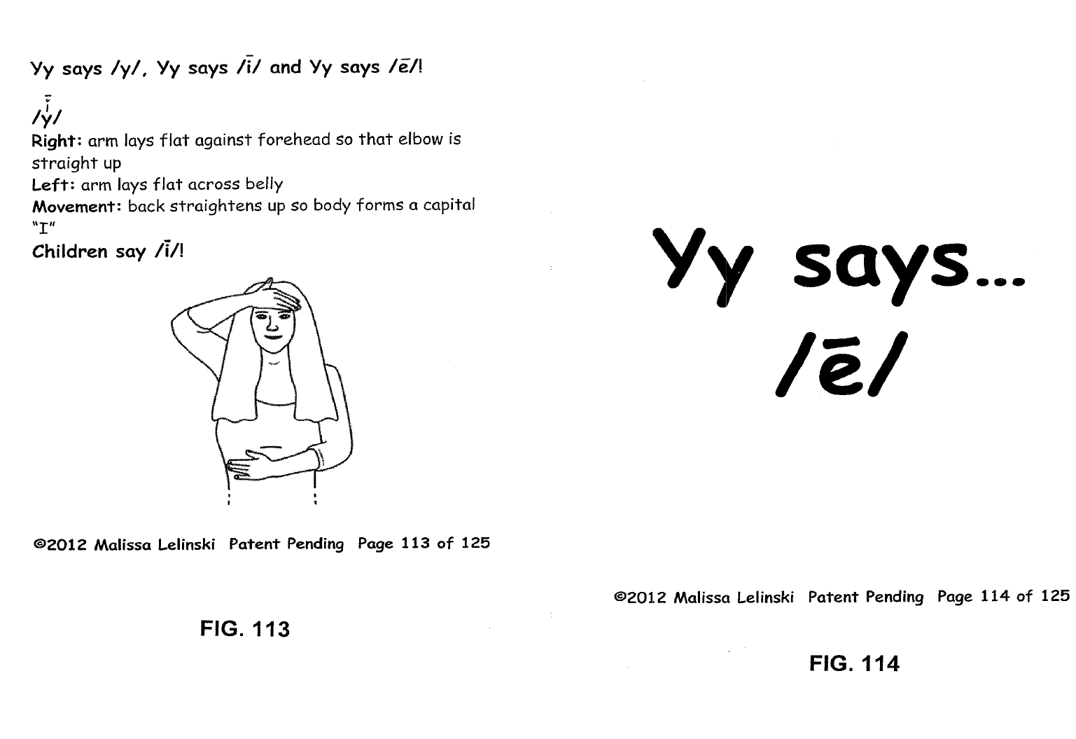

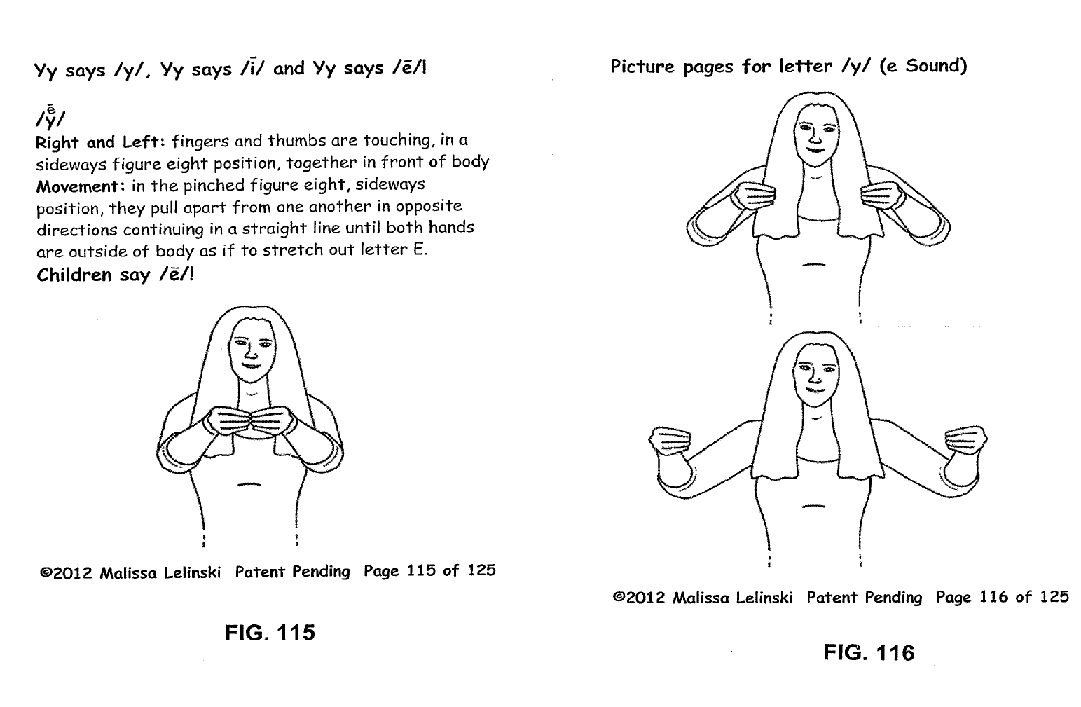

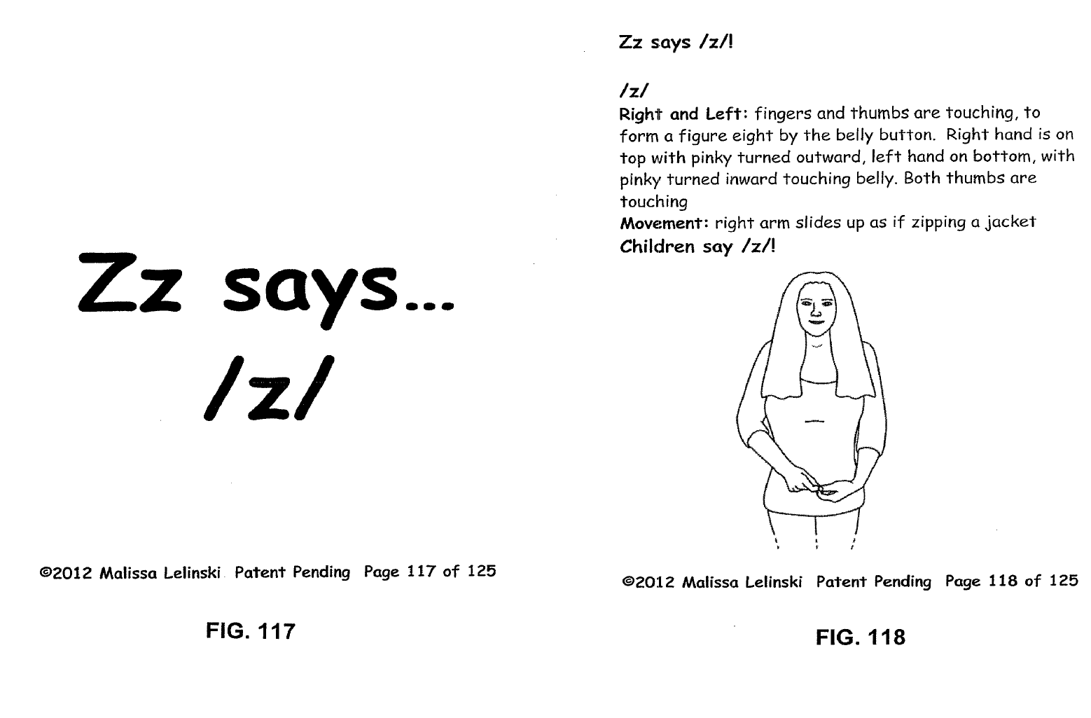

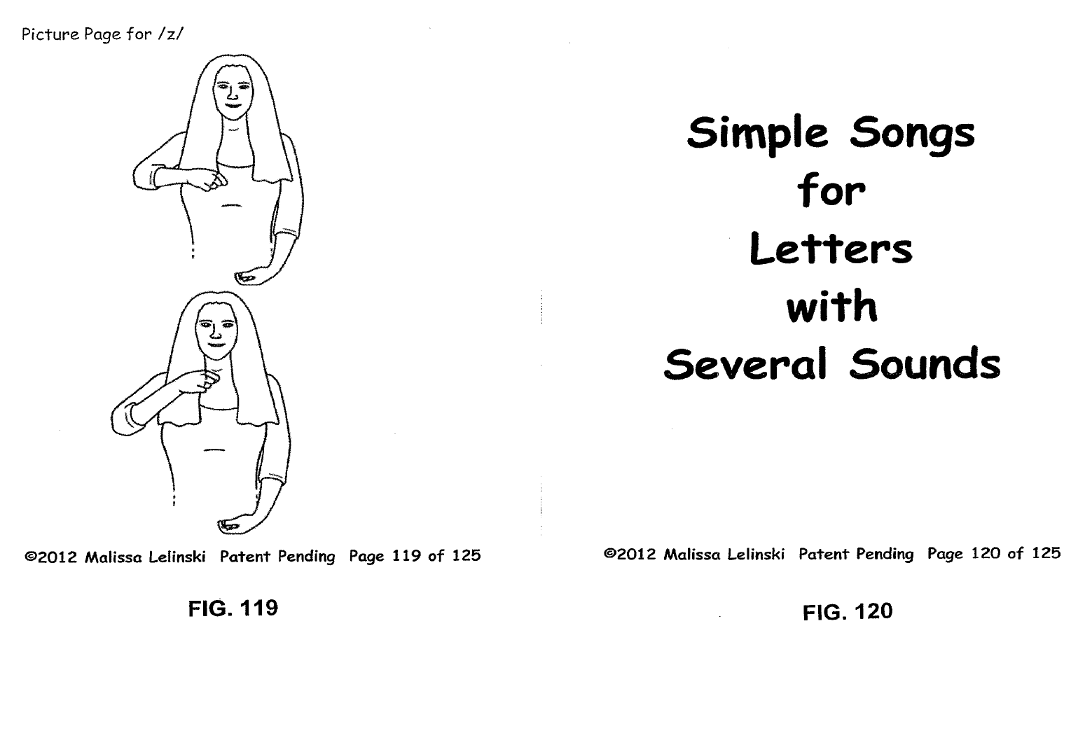

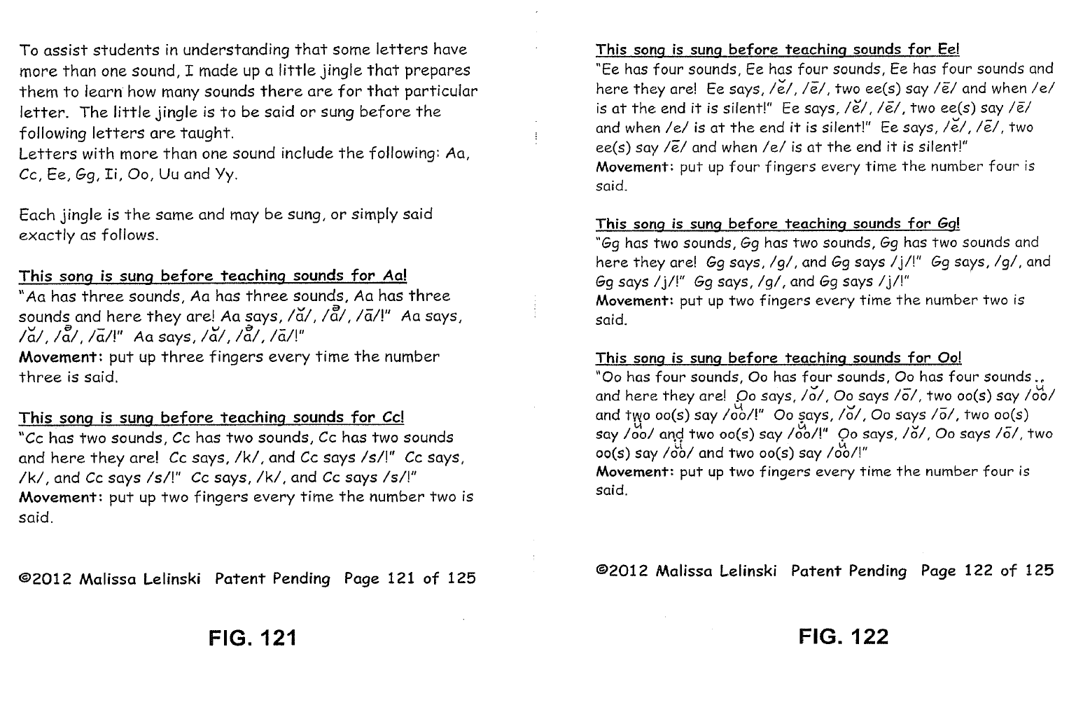

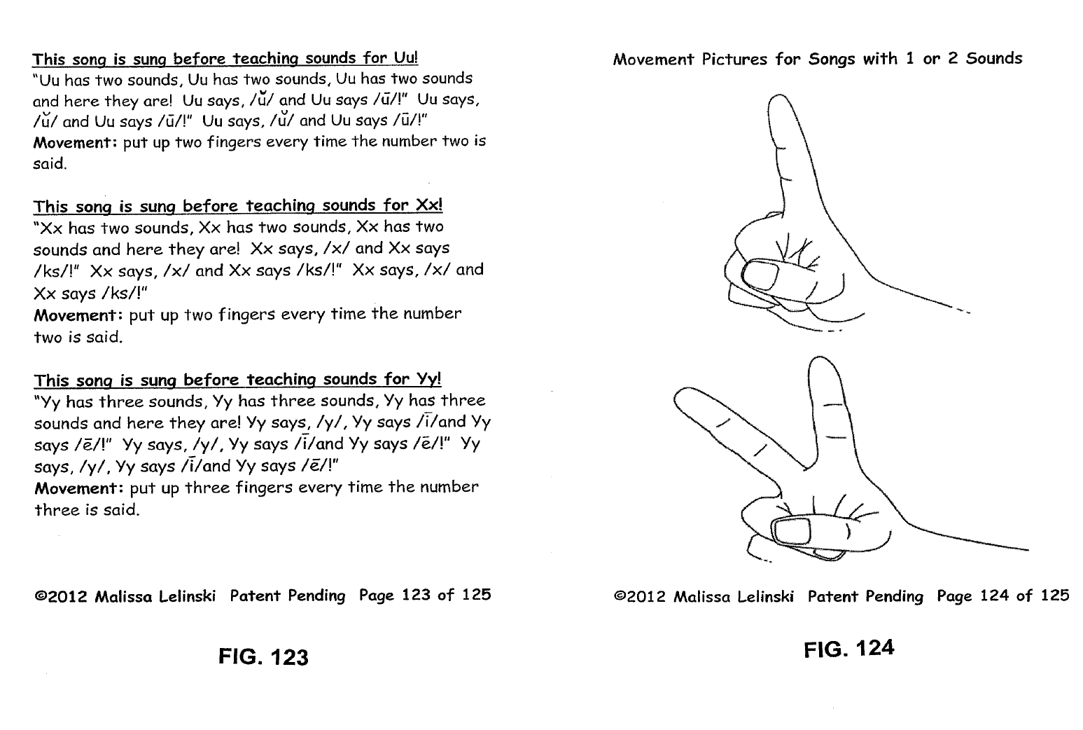

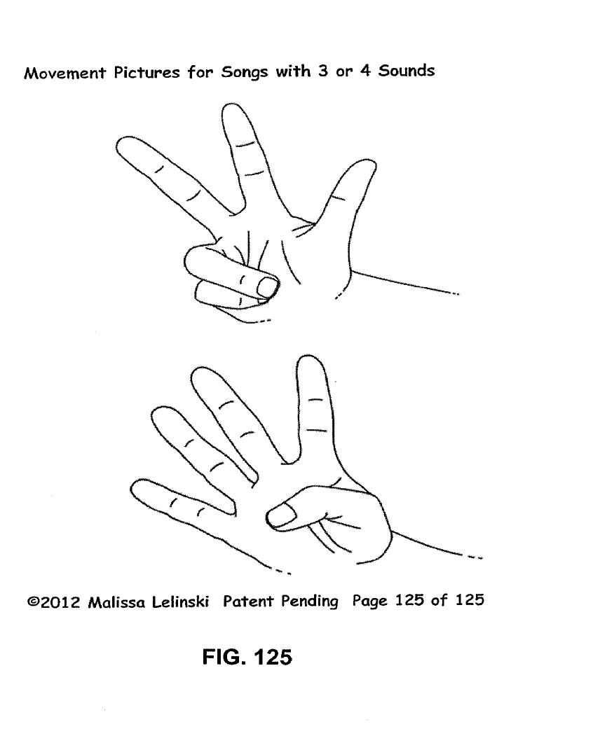

Beginning with FIGS. 1-11, they show the “A” or “a” sound, together represented as the “Aa” sound, which sound can have several variations of audio profile. For example, FIGS. 2 and 3 show first that the “Aa” sound can “say” or sound like /\check{a}/. Visually, the teacher starts by facing the students. She is about to position herself, her arms, hands and/or fingers in what will be referred to herein as a “first visual cue.” From this first visual cue, the teacher will move and repeat a “second visual cue.” In this instance, the first visual cue is established when she raises and holds her right arm and elbow at a 90° angle, with her fingers touching her thumb. At the same time, the teacher raises and holds her left arm and elbow also at a 90° angle, with her palm up and finger open, flat and facing left. The teacher moves her right hand from right to left, crossing over her body to tap the middle of her left palm. This is the second visual cue. This movement of the second visual cue is intended to demonstrate the placement of an apple onto the teacher's left palm as the students say “/\check{a}/,” which sounds like the letter “a” in the word “apple.”

It is to be noted here that all letters of the English alphabet, as discussed herein will demonstrate a first visual cue, a second visual cue and an audible sound that is tied, in some fashion, to those visual cues. These are the cues that establish a link between the cues and the letters themselves, as will be apparent in this detailed description.

Continuing with FIGS. 4 and 5, it is demonstrated that the “Aa” sound can also “say” or sound like / [symbol] /. Visually, the teacher, facing the students, keeps each elbow touching that side of her body, palms up, with fingers touching the thumb as she turns a pinched grip to face forward. The fingers on each hand then move in the pinched grip slowly toward, and meet at, the teacher's belly button. Her shoulders go up when both sets of fingers meet at the belly button. This movement is intended to demonstrate a belly “poke” with the associated sound “uh” as one might say when poked in the belly and which is verbalized at the same time.

In FIGS. 6-8, it is demonstrated that the “Aa” sound can also say or sound like /ā/. Visually, the teacher, again first facing the students, places her fingers in the thumb of each hand in a closed position, touching them together, much like a figure “8” position. In the pinched FIG. 8 position, the teacher slowly pulls her hands away from one another as if stretching out the letter “a” in the “long a” sound /ā/ and which is verbalized at the same time. It is to be noted that the teaching method for the long vowel sounds of Aa, Ee and Oo are similar in this regard.

In FIGS. 9-11, the sound made with an “a” when the “a” stands alone in a sentence, or the like, is demonstrated. This sound is similar to that of the / [symbol] / discussed above. However, prior to the “uh” of the belly poke being made, the teacher starts with her first visual cue by extending her forearms in front of her body with her elbows touching her sides. From this position, the right arm is raised up and the left arm goes down. This motion is alternated between arms and is continued as if the teacher was “wiping away” all other letters to make the “Aa” stand alone. After this is done, the belly poke is made and the children say “uh” or “/ [symbol] /!”

Next, FIGS. 24-34 show the “E” or “e” sound, together represented as the “Ee” sound, which′ sound can have four variations. For example, FIGS. 24-26 show the first variation where the “Ee” sound can “say” or sound like /\check{e}/. Visually, the teacher starts by standing in front of the students with her left side facing the students. The teacher then closes the first of her right hand and moves the first to touch her nose. From that position, the teacher then moves her closed first by swinging it down and up in front of her body. This movement is intended to trace or convey the shape of an elephant's trunk as the students say “/\check{e},” which sounds like the first “e” in the word “elephant.”

In FIGS. 27-29, it is demonstrated that the “Ee” sound can also say or sound like /ē/. Visually, the teacher, facing the students, again places her fingers within the thumb of each hand in a closed position and then touches them together in the figure “8” position. In the pinched figure 8 position, the teacher slowly pulls her hands away from one another as if “stretching” out the letter “e” in the “long e” sound /ē/, which is verbalized at the same time by the teacher and the students.

FIGS. 30-32 show that “Ee” can also have the “long e” sound /ē/ where two “ee(s)” are used together in a word. Facing the students, the teacher places her arms and elbows at a 90° angle with her palms facing forward, fingers are bent over to touch the top of the palms, and both thumbs are tucked in to touch the palms. From this position, the teacher moves both hands together in a sliding motion until the thumbs touch each other. At the same time, the teacher and students say the twin ee(s) touch and make one sound, “e!”

FIGS. 33 and 34 show that, when the “Ee” sound is used at the end of a word, the /e/ sound is to be “silent.” Visually, the teacher places the “pointer” finger of her right hand directly over her closed lips, the finger sitting against the middle of her mouth. The teacher then gently taps her pointer finger to her lips to motion or signal to be quiet. At the same time, the students whisper the word “silent!”

Continuing with application of the method of the present invention as applied to the vowels of the English alphabet, FIGS. 47-54 demonstrate that the letter “I” or “i” sound, together represented as the “Ii” sound, can “say” or sound three variations. For example, FIGS. 47 and 48 show the first variation where the “Ii” sound can “say” or sound like /Ī/, which is the long “i” sound. Facing her students, the teacher lays her right arm flat against her forehead so that the elbow is straight up. The left arm lays flat across her belly. From that position, the teacher straightens up her back, effectively forming a capital “I”, and the children say “/Ī/!”

Similarly, FIGS. 49 and 50 show that the “Ii” sound can also say or sound like /\check{I}/. Again facing her students, the teacher takes her right hand and holds it in front of her body as she pinches her fingers together. From this position, the teacher opens and closes her pinched fingers, extending them outwardly as if something is “icky.” See FIG. 51. As this motion is made, the children say “/\check{I}/!”

Lastly, FIGS. 52-54 show that the “Ii” sound can also say or sound like /Ī/, which is the long “i” sound, when the “I” stands alone. Facing her students, the teacher lays her right arm flat against her forehead so that the elbow is straight up. The left arm lays flat across her belly. From that position, the teacher straightens up her back, effectively forming a capital “I”, and the children say “/Ī/!”

The vowel “Oo” also sounds like or says /\check{o}/ or /ō/, and two oo(s) sound two different ways. These are illustrated in FIGS. 70-81. Starting with the “Oo” sounds like /\check{o}/, the teacher starts by holding her right arm and elbow at 90° with the fingers and her thumb on that hand forming a circle, the fingers and thumb pointing towards her face. From this position, the teacher opens and closes the circle while also forming a circle with her mouth. During these motions, the children say “/\check{o}/!”

Where “Oo” sounds like or says /ō/, the teacher, facing the students, places her fingers within the thumb of each hand in a circle position and then touches them together in the figure “8” configuration. See FIGS. 74 and 75. In the pinched FIG. 8 position, the teacher slowly pulls her hands away from one another as if “stretching” out the letter “o” in the “long o” sound. As she does this, the children say “/ō/!”

Where two oo(s) say /ₒₒ^{ü}/, the teacher starts from a position where she has both her right and left hands and fingers forming open circles, but the left hand crosses in front of her body and sits diagonally in front of the right hand circle. From this position, and for the second visual cue, the teacher shifts her full body to the left as both circles are lifted up to meet her left shoulder, as if to say “ooooo” that is pretty! See FIGS. 77 and 78. During this second visual cue, the children say “/ₒₒ^{ü}/!”

Where two oo(s) say /ₒₒ^{ü}/, the teacher starts by positioning both arms and elbows at 90° angles, with her hands forming an open circle with the thumbs and fingers facing outward. This is the first visual cue. From this position, the teacher extends her hands over her head and brings them back to the point of beginning, as if she was lifting something that is very heavy. See FIGS. 80 and 81. This is repeated and is the second visual cue. As this motion is repeated, the children say “/ₒₒ^{ü}/!”.

Continuing with the letter “Uu,” FIGS. 95-99 show that “Uu” can sound or say /\check{u}/ or /ū/. Where “Uu” says /\check{u}/, the teacher's first visual cue is to take her right hand and raising it up above her head. From this position, her fingers are spread and the arm swings forward, hanging them in front of her forehead as if shielding herself by using an umbrella. During this movement, the children say “/\check{u}/!” Where “Uu” says /ū/, the teacher positions herself such that her left shoulder is facing the children. The teacher then establishes the first visual cue by taking the closed first of her right hand and touching her forehead with it. From this position, the teacher moves her right first in an upward and outward motion away from her forehead, as if forming a unicorn's horn. During this motion, the children say “/ū/!”

Lastly, the letter “Yy” can be considered as a vowel or as a consonant. In this detailed description, the letter “Yy” will be treated as a consonant and will be discussed below.

### Consonants

Referring now to the use of the method of the present method with consonants of the English language, FIGS. 12-14 show that the “Bb” sound says /b/ which is demonstrated by the teacher first extending her arm in front of her body, palm facing down and fingers spread apart. That arm and hand then moves in an up and down motion, much like bouncing a ball. As this movement is being done, the children say “/b/!” Again, the concepts of the first and second visual cues and the audible sound are used, as described above.

FIGS. 15-20 show that the “Cc” sound has two variations. First, the “Cc” sound can “say” /k/. It can also “say” /s/. FIG. 16 illustrates that the teacher take her right thumb and pointer finger, touching together, on the right outside corner of her lip. The same position is mirrored on the left hand. From this position, the teacher opens and closes the thumb and pointer finger, moving the left hand to the left and the right hand to the right, as if stretching out the long whiskers of a cat. See also FIG. 17. At the same time, the children say “/k/!”

FIGS. 19 and 20 illustrate that, in a variation of the “Cc” sound, the teacher takes her right pointer finger and points it to the left, lying sideways over her closed lips. From this position, the teacher moves her finger outward and away from her mouth in an “up and down” motion, making a shape that would be similar to that of a snake slithering its tongue. At the same time, the children say “/s/!” which would be the sound of a hissing snake. The movements for this second sound of “Cc” are the same for the letter “Ss” as is shown in FIGS. 89-91.

Next, FIGS. 21-23 show that the “Dd” sound says /d/ which is demonstrated by the teacher first extending her right arm in front of her, with fingers touching the thumb and the pointer finger pointing up, which creates a lowercase “d”. The lowercase “d” is then pulled close to the teacher's body and faces to the left. From this position, the pointer finger moves in an up and down motion, much like the hand is dancing. As this movement is being done, the children say “/d/!”

FIGS. 35 and 36 show that the “Ff” sound says /f/ which is demonstrated by the teacher first placing her hands together, palm to palm, with her fingers pointing forwardly from her body. From this position, and keeping both hands together, the teacher moves her hands in a “zig-zag” motion, which resembles the back and forth movement of a fish as it swims. See FIG. 37. As this movement is being done, the children say “/f/!”

Next, FIGS. 38-42 show that the “Gg” sound “says” either /g/ or /j/. For the /g/ sound, the teacher starts with her right arm and elbow in front of her, with the bottom three fingers touching the palm. The pointer finger and the thumb face left. From this position, the teacher moves her right wrist with a twisting motion so that her thumb moves from top to bottom, as if she was pretending to wiggle a green grape. During this movement, the children say “/g/!” See FIG. 40. Where the “Gg” sound says /j/, the teacher starts by extending her right elbow in front of her body, with her hand going gently around the front of her neck. From this position, the right hand is extended upwardly and out, much like the stretching out of the neck of a giraffe. During this movement, the children say “/j/!” See FIGS. 42 and 43.

FIGS. 44-46 show students that the “Hh” sound “says” /h/ which is demonstrated by the teacher positioning her right and left elbows in 90° angles, with her palms facing towards her body. From this position, the teacher moves both of her hands up and down, as if she were “fanning” her face because she is hot. During this movement, the children say “/h/!”

FIGS. 55-57 show students that the “Jj” sound “says” /j/ which is demonstrated by the teacher bending her upper arms and elbows in 90° angles, with her palms facing forward. From this position, the teacher raises her elbows and hands in an “up and down” motion as if her hands and arms are lumping. During this movement, the children say “/j/!”

FIGS. 58-60 show students that the “Kk” sound “says” /k/ which is demonstrated by the teacher positioning her right and left elbows and then raising her hands high above her head. From this position, the teacher raises her hands up and down on top of her head as if she was placing the crown of a king onto her head. During this movement, the children say “/k/!”

FIGS. 61 and 62 show students that the “Ll” sound “says /l/ which is demonstrated by the teacher positioning her right hand such that the thumb faces left and the pointer finger points up until the shape of an “L” is made with her right hand. From this position, the right hand moves across her body in a straight line, from left to right, and in a straight line, with the teacher facing the students. This indicates that the “Ll” sound is “long.” During this movement, the children say “/l/!”

FIGS. 64-66 show students that the “Mm” sound says /m/ which is demonstrated by the teacher positioning her right hand and palm on her belly. From this position, the teacher moves her hand in a circular clockwise motion over her belly to indicate that something is “mmmm” good! During this movement, the children say “/m/!”

FIGS. 67-69 show students that the “Nn” sound says /n/ which is demonstrated by the teacher taking her right hand such that her thumb points to the right, and her fingers are extended and placed gently under her chin, which is also raised slightly. From this position, the teacher moves her fingers downwardly, sliding them over her Adam's apple and touching her neck gently from top to bottom. During this movement, the children say “/n/!”

FIGS. 82-84 show students that the “Pp” sound says /p/ which is demonstrated by the teacher extending her right arm diagonally outward from her body, taking her right hand with her palm facing downwardly, and spreading her fingers apart. From this position, the teacher moves the finders of her right hand together in a pinched grip, as if picking up a pickle, and slightly raises her right hand. During this movement, the children say “/p/!”

FIGS. 85 and 86 show students that the “Qq” sound says /q/ which is demonstrated by the teacher placing her right hand in front of her mouth with the pointer finger pointing up as it rests directly over her closed lips, the finger sitting against the middle of her mouth. From this position, the teacher gently taps her pointer finger against her lips as if motioning for the children to be quiet. During this movement, the children say “/q/!”

FIGS. 87 and 88 show students that the “Rr” sound says /r/ which is demonstrated by the teacher elevating both arms and elbows, at about a 90° angle to one another, with her fingers of each hand spread apart facing forward and forming a claw. From this position, the teacher leans her body forward and grits her teeth together, lips open, as if making a growl or roar of an animal. During this movement, the children say “/r/!”

FIGS. 89-91 show students that the “Ss” sound says /s/ which is demonstrated by the teacher raising her right hand to her mouth and using her pointer finger to point left as it is lying sideways over closed lips. From this position, the teacher moves her finger outward, away from her mouth, in an up and down motion making mini-hills that replicate the slithering of a snake. It should be noted that this is the same motion made for the “Cc” sound where the “Cc” sound says /s/. During this movement, the children say “/s/!”

FIGS. 92-93 show students that the “Tt” sound says /t/ which is demonstrated by the teacher taking her right hand, point finger pointing upward and her hand forming the lowercase letter “d.” The same position is made with respect to the left hand, but where the pointer finger of the right hand is positioned slightly above the pointer finger of the left hand. From this position, the pointer finger of the right hand moves down to tap the pointer finger on the left hand, thereby creating the letter “Xx” in front of the body. The fingers are repeatedly raised and lowered as if tapping one another. During this movement, the children say “/t/!”

FIGS. 100-102 show students that the “Vv” sound says /v/. This is demonstrated by the teacher raising both her arms to form 90° angles with the elbows. The pointer fingers and middle fingers stand up to create the letter “V” on both hands. Both “V” s are then tipped inward and on their sides towards the body and come to rest below her shoulders. From this position, the sideways “V” s move up and down and over the front of her body as if making a vest. During this movement, the children say “/v/!”

FIGS. 103 and 104 show students that the “Ww” sound says /w/ which is demonstrated by the teacher standing in front of the students with her left side facing them. She then raises her right hand with the pointer, middle and ring fingers standing up on that hand. The palm faces forward, which is to the teacher's left, with the thumb and pinky finger touching to create a shape of the letter “W.” The hand is then moved to her mouth, facing up. From this position, the “W” shape of her hand taps gently as if drinking a cup or glass of water. During this movement, the children say “/w/!”

FIGS. 105-108 show that, as another exception (like “Cc” and “Gg”) to the rule that each consonant typically has only one sound, the letter “Xx” says /ks/ and /x/. With respect to both the /ks/ sound and the /x/ sound, the teacher starts out with both arms in front of her body. Each hand forms a closed fist. From this position, the teacher crosses her forearms in front of her and then taps her forearms together making a cross or the letter “X.” During this movement, the children say “/ks/!” or “/x/!” as the case may be.

FIGS. 109-116 show that the letter “Yy” says /y/, /ī/ and /ē/. Starting with the method of the present invention where the letter “Yy” says /y/, the teacher starts by facing the students. The teacher then takes the pointer, middle and ring finger of her right hand and pointing them down, touching her palm. The thumb points to the left and the pinky point to the right. From this position, the teacher moves her full right arm and hand up and down like a yo-yo. See FIG. 111. During this movement, the students say “/y/!”

In the case where “Yy” says /ī/, the teacher faces the students and raises her right arm in front of her such that the arm lays flat against her forehead so that the right elbow is straight up. The teacher then places her left arm in front of her such that the left arm lays flat across her belly. In this position, the teacher straightens her back in such a way that her torso and arms form the letter capital “I.” See FIG. 113. During this motion, the students say “/ī/!”

In the case where “Yy” says /ē/, the teacher faces the students and the again places her fingers in thumbs of each hand in a closed position, touching them together in the figure “8” position. See FIG. 115. In the pinched FIG. 8 position, the teacher slowly pulls her hands away from one another as if stretching out the letter “e” in the “long e” sound /ē/ and which is verbalized at the same time by the teacher and the students as “/ē/!”

FIGS. 117-119 show that “Zz” says /z/, the teacher starts by facing the students and then placing her right and left hands such that the fingers and thumbs of each hand touch to form a FIG. 8 in the vicinity of her belly button. Her right hand is on top with the right pinky finger turned outward. Her left hand is on the bottom, with her left pinky finger turned inward, touching the belly. Both thumbs are touching. From this position, the teacher slides her right arm upwardly as if zipping a jacket. At the same time, the children say “/z/!”

It is also to be understood that the method and system of the present invention can be used within a specific non-transitory computer program product embodied in a non-transitory computer readable medium or that is used separately from or within an electronic commerce (or “e-commerce”) environment and that comprises certain system building block “components.” Those components are data structures, data processors and interfaces, and each component is a functional element. The data structures are places to organize and store data. The data processors are used to manipulate data by performing processes or applying algorithms to the data. The interfaces connect the data structures and the data processors to the outside world, or to other data structures and data processors, including the virtual internet-based community that exists within the “world wide web” or “www.” The program includes source code which is a list of instructions, written in a selected computer language, and then converted into computer machine language, which language the computer uses to build the software “machine” described by the instructions. The software machine is made up of the components referred to above. The source code is a detailed “blueprint” telling the computer how to assemble those components into the software machine. Further, the source code is organized into separate files, files are organized into separate modules, and modules are organized into separate functions or routines to accomplish, via pre-programmed algorithms, the necessary steps in accordance with the method and system of the present invention. It is to be understood that the specific way that the source code is organized into files, modules and functions is a matter of programmer design choice and is not a limitation of the present invention.

The principles of this invention being described in accordance with the foregoing, I claim as my invention the following:

1. A method used by a teacher to teach a letter of the English alphabet to students, the method comprising the steps of:
identifying the letter to be taught to the students;
providing a first visual cue for the students, such first visual cue comprising a first position for the body, arms, hands and/or fingers of the teacher and establishing a starting point for further body, arm, hand and/or finger movement by the teacher;
providing a second visual cue for the students, such second visual cue comprising a repeated motion or movement of the teacher's body, arms, hands and/or fingers from the starting point which is the first visual cue; and
providing an audible sound relating to the letter, such sound being made by the students.

2. The teaching method of claim 1 wherein the audible sound providing step further comprises the teacher and students making the sound in unison.

3. The teaching method of claim 2 wherein the audible sound providing step further comprises the teacher and students repeating the sound.

4. A system used by a teacher to teach letters of the English alphabet to students comprising:
means for identifying the letters to be taught to the students;
a first visual cue for the students for each letter identified, such first visual cue comprising a first position for the body, arms, hands and/or fingers of the teacher, which first position establishes a starting point for further body, arm, hand and/or finger movement by the teacher;
a second visual cue for the students for each letter identified, such second visual cue comprising a repeated movement of the teacher's body, arms, hands and/or fingers from the starting point of the first visual cue; and
an audible sound relating to each letter identified, such sound being made by the teacher and the students.

5. The teaching system of claim 4 wherein the audible sound comprises the teacher and students making the sound in unison.

6. The teaching system of claim 5 wherein the audible sound comprises the teacher and students repeating the sound.

7. A computer program product for teaching the letters of the English alphabet to students, the computer program product being embodied in a non-transitory computer readable medium comprising computer instructions for:
generating at least one interface, the at least one interface comprising a screen display and an audio output;
allowing a user to choose a letter to be taught to the students;
providing a first visual cue on the screen display for that letter for the students, such first visual cue comprising a first position for the body, arms, hands and/or fingers of the teacher and establishing a starting point for further body, arm, hand and/or finger movement by the teacher;
providing a second visual cue on the screen display for that letter for the students, such second visual cue comprising a repeated movement of the teacher's body, arms, hands and/or fingers from the starting point;
providing an audible sound via the audio output, such sound relating to the letter;
providing instructions to the students to make the audible sound.

8. The product of claim 7 wherein the audible sound instructions instruct the students to repeat the sound a plurality of times.
